(19) United States
(12) Patent Application Publication
(10) Pub. No.: US 2026/0111750 A1
(43) Pub. Date: Apr. 23, 2026

(54) PRIVACY-PRESERVING SYNTHESIS OF ARTIFICIAL DATA

(71) Applicant: VISA INTERNATIONAL SERVICE ASSOCIATION, San Francisco, CA (US)

(72) Inventors: Sebastian Meiser, Lubeck (DE); Mangesh Bendre, Sunnyvale, CA (US); Mahashweta Das, Campbell, CA (US)

(73) Assignee: VISA INTERNATIONAL SERVICE ASSOCIATION, San Francisco, CA (US)

(21) Appl. No.: 19/153,163

(22) PCT Filed: Feb. 2, 2023
(86) PCT No.: PCT/US2023/061884

§ 371 Date: Aug. 1, 2025

(51) Int. Cl. G06N 3/094; G06F 16/215; G06F 21/62; G06N 3/0475

(52) U.S. Cl. CPC G06N 3/094; G06F 16/215; G06F 21/6218; G06N 3/0475

(57) ABSTRACT

Embodiments of the present disclosure are directed to the methods and systems for generating artificial data records from (potentially private or sensitive) data records in a privacy-preserving manner, particularly using machine learning models such as generative adversarial networks (GANs). Such artificial data records can be used in place of the real data in data analysis applications, such as training machine learning models. These artificial data records can be generated such that they do not (or have a low or negligible probability of) leaking information from the data records used to generate the artificial data records. As a result, artificial data records (or any machine learning models trained to generate such artificial data records) can potentially be published or distributed without violating rules, regulations, or laws restricting the transmission of sensitive data.

### BACKGROUND

Data can be analyzed for a variety of useful purposes. For example, user data collected by a streaming service can be used to recommend shows or movies to users. For a particular user, the streaming service can identify other similar users (e.g., based on common user data characteristics) and identify shows or movies watched by those similar users. These shows or movies can then be recommended to the user. Given the similarity of the users, it is more likely that the user will enjoy the recommended shows, and as such, the streaming service is providing a useful recommendation service to the user. As another example, A bank can use user transaction data to generate a model of user purchasing patterns. Such a model can be used to detect fraudulent purchases, for example, purchases made using a stolen credit card. The bank could use this model to detect if fraudulent purchases are being made, alert a cardholder, and deactivate the stolen card. In this way, user data can be used to provide a useful service to users.

In some cases, data may be considered sensitive or confidential, e.g., containing information that data subjects (such as users) may not want disclose or otherwise make publicly available. Recent concerns about data privacy have lead to the widespread adoption of data privacy rules and regulations. Governments and organizations now often limit the use, storage, and transmission of data, particularly the transmission of user data across country borders. While these regulations expand and protect the individual right to privacy, they limit the ability to use user data to provide useful services, such as those described above.

In some circumstances, such rules and regulations can lead to problems. As an example, a country may experience a serious viral outbreak, which necessitates the aid of the greater global community. The country may collect biological data from afflicted citizens, which can be used to research a treatment or vaccine. The country's laws (or the laws of a larger economic, defensive, or administrative partnership to which the country belongs) may prohibit the transmission of this sensitive biological data outside of the country, thereby slowing research and development into a treatment or vaccine.

Some recent scientific literature has proposed privacy-preserving methods for data processing, including creating complex machine learning models. These methods can be used to analyze sensitive data without violating privacy. However, these solutions have several problems that make them less useful in practice. As one example, these solutions often need to be tailored to their specific use cases (e.g., financial data analysis, health data analysis, etc.) and often require significant domain knowledge by the developers implementing such models. The developers of these models further need to have a strong background in the correct application of privacy techniques, not only during the model deployment but also during the model development process itself. If privacy techniques are not applied (or even applied incorrectly), a third party with access to the model (e.g., via an application programming interface) can use their access to sensitive information about private data used to train the model.

Embodiments address these and other problems, individually and collectively.

### SUMMARY

Embodiments are directed to methods and systems for synthesizing privacy-preserving artificial data. Embodiments can use machine learning models, such as generative adversarial networks (GANs) to accomplish this synthesis. In some embodiments, a data synthesizer (implemented, for example, using a computer system) can perform initial pre-processing operations on potentially sensitive or private input data records to remove outliers and guarantee “differential privacy” (a concept described in more detail below). This input data can be used to train a machine learning model (e.g., a GAN) in a privacy-preserving manner to generate artificial data records, which are generally representative of the input data records used to train the model. These artificial data records preserve the privacy of these input data records.

Afterwards, a trained generator model can be used to generate an artificial data set which can be transmitted to client computers or published. Alternatively, the trained generator model itself can be published or transmitted. In embodiments, the privacy guarantees can be strong enough that privacy is preserved even under “arbitrary post-processing.” That is, a client computer (or its operator) can process the data as it sees fit without risking the privacy of any sensitive data records used to train the generator model. For example, the client computer could use the artificial data to train a machine learning model to perform some form of classification (e.g., classifying credit card transactions as normal or fraudulent). The operator of a client computer does not need to have any familiarity with privacy-preserving techniques, standards, etc., when performing arbitrary data analysis on the artificial data set or using the trained generator to generate an artificial data set.

In more detail, one embodiment is directed to a method performed by a computer system for training a machine learning model to generate a plurality of artificial data records in a privacy-preserving manner. The computer system can retrieve a plurality of data records (e.g., from a database). Each data record can comprise a plurality of data values corresponding to a plurality of data fields. Each data field can be within a category of a plurality of categories. The computer system can determine a plurality of noisy category counts corresponding to the plurality of categories. Each noisy category count can indicate an estimated number of data records of the plurality of data records that belong to each category of the plurality of categories. The client computer can use the plurality of noisy category counts to identify one or more deficient categories. Each deficient category can comprise a category for which a corresponding noisy category count is less than a minimum count. The computer system can combine each deficient category of the one or more deficient categories with at least one other category of the plurality of categories. In this way, the computer system can determine a plurality of combined categories. The computer system can identify one or more deficient data records. Each deficient data record can contain at least one deficient data value corresponding to a combined category. For each deficient data value contained in the one or more deficient data records, the computer system can replace the deficient data value with a combined data value identifying a combined category of the plurality of combined categories. The computer system can generate a plurality of conditional vectors, such that each conditional vector identifies one or more particular data values for one or more particular data fields of the plurality of data fields. The computer system can sample a plurality of sampled data records from the plurality of data records. This plurality of sampled data records can include at least one of the one or more deficient data records. Each sampled data record can comprise a plurality of sampled data values corresponding to the plurality of data fields. Afterwards, the computer system can train a machine learning model to generate the plurality of artificial data records. Each artificial data record can comprise a plurality of artificial data values corresponding to the plurality of data fields. In accordance with the conditional vectors, the machine learning model can generate the plurality of artificial data records such that the machine learning model can replicate one or more sampled data values corresponding to the one or more particular data fields in the plurality of artificial data values.

Another embodiment is directed to a method of training a machine learning model to generate a plurality of artificial data records that preserve privacy of sampled data values contained in a plurality of sampled data records. This method can be performed by a computer system. The computer system can acquire a plurality of sampled data records, each sampled data record comprising a plurality of sampled data values. The computer system can likewise acquire a plurality of conditional vectors, each conditional vector can identify one or more particular data fields. The computer system can then perform an iterative training process comprising several steps described in further detail below. The computer system can determine one or more chosen sampled data records of the plurality of sampled data records. Likewise, the computer system can determine one or more chosen conditional vectors of the plurality of conditional vectors. Afterwards, the computer system can identify one or more conditional data values from the one or more chosen sampled data records, the one or more conditional data values corresponding to one or more particular data fields identified by the one or more chosen conditional vectors. The computer system can generate one or more artificial data records using the one or more conditional data values and a generator sub-model. The generator sub-model can be characterized by a plurality of generator parameters. The computer system can generate one or more comparisons using the one or more chosen sampled data records, the one or more artificial data records, and a discriminator sub-model. Like the generator sub-model, the discriminator sub-model can be characterized by a plurality of discriminator parameters. The computer system can determine a generator loss value and a discriminator loss value based on the one or more comparisons. The computer system can generate one or more generator update values based on the generator update value. Likewise, the computer system can generate one or more initial discriminator update values based on the discriminator loss value. The computer system can generate one or more discriminator noise values, and generate one or more noisy discriminator update values by combining the one or more initial discriminator update values and the one or more discriminator noise values. The computer system can update the generator sub-model by updating the plurality of generator parameters using the one or more generator update values. The computer system can likewise update the discriminator sub-model by updating the plurality of discriminator parameters using the one or more noisy discriminator update values. The computer system can determine if a terminating condition has been met, and if the terminating condition has been met, the computer system can terminate the iterative training process, otherwise the computer system can repeat the iterative training process until the terminating condition has been met.

Other embodiments are directed to computer systems, non-transitory computer readable media, and other devices that can be used to implement the above-described methods or other methods according to embodiments.

### Terms

A “server computer” may refer to a computer or cluster of computers. A server computer may be a powerful computing system, such as a large mainframe. Server computers can also include minicomputer clusters or a group of servers functioning as a unit. In one example, a server computer can include a database server coupled to a web server. A server computer may comprise one or more computational apparatuses and may use any of a variety of computing structures, arrangements, and compilations for servicing requests from one or more client computers.

A “client computer” may refer to a computer or cluster of computers that receives some service from a server computer (or another computing system). The client computer may access this service via a communication network such as the Internet or any other appropriate communication network. A client computer may make requests to server computers including requests for data. As an example, a client computer can request a video stream from a server computer associated with a movie streaming service. As another example, a client computer may request data from a database server. A client computer may comprise one or more computational apparatuses and may use a variety of computing structures, arrangements, and compilations for performing its functions, including requesting and receiving data or services from server computers.

A “memory” may refer to any suitable device or devices that may store electronic data. A suitable memory may comprise a non-transitory computer readable medium that stores instructions that can be executed by a processor to implement a desired method. Examples of memories including one or more memory chips, disk drives, etc. Such memories may operate using any suitable electrical, optical, and/or magnetic mode of operation.

A “processor” may refer to any suitable data computation device or devices. A processor may comprise one or more microprocessors working together to achieve a desired function. The processor may include a CPU that comprises at least one high-speed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and/or Xscale; and/or the like processor(s).

A “message” may refer to any information that may be communicated between entities. A message may be communicated by a “sender” to a “receiver”, e.g., from a server computer sender to a client computer receiver. The sender may refer to the originator of the message and the receiver may refer to the recipient of a message. Most forms of digital data can be represented as messages and transmitted between senders and receivers over communication networks such as the Internet.

A “user” may refer to an entity that uses something for some purpose. An example of a user is a person who uses a “user device” (e.g., a smartphone, wearable device, laptop, tablet, desktop computer, etc.). Another example of a user is a person who uses some service, such as a member of an online video streaming service, a person who uses a tax preparation service, a person who receives healthcare from a hospital or other organization, etc. A user may be associated with “user data”, data which describes the user or their use of something (e.g., their use of a user device or a service). For example, user data corresponding to a streaming service may comprise a username, an email address, a billing address, as well as any data corresponding to their use of the streaming service (e.g., how often they watch videos using the streaming service, the types of videos they watch, etc.). Some user data (and data in general) may be private or potentially sensitive, and users may not want such data to become publicly available. Some user data (and data more generally) may be protected by privacy rules, regulations and/or laws which prevent its transmission.

A “data set” may refer to a collection of related sets of information (e.g., “data”) that can comprise separate data elements and that can be manipulated and analyzed, e.g., by a computer system. A data set may comprise one or more “data records,” smaller collections of data that usually correspond to a particular event, individual, or observation. For example, a “user data record” may contain data corresponding to a user of a service, such as a user of an online image hosting service. A data set or data contained therein may be derived from a “data source”, such as a database or a data stream.

“Tabular data” may refer to a data set or collection of data records that can be represented in a “data table,” e.g., as an ordered list of rows and columns of “cells.” A data table and/or data record may contain any number of “data values,” individual elements or observations of data. Data values may correspond to “data fields,” labels indicating the type or meaning of a particular data value. For example, a data record may contain a “name” data field and an “age” data field, which could correspond to data values such as “John Doe” and “59”. “Numerical data values” can refer to data values that are represented by numbers. “Normalized numerical data values” can refer to numerical data values that have been normalized to some defined range. “Categorical data values” can refer to data values that are representative of “categories,” i.e., classes or divisions of things based on shared characteristics.

An “artificial data record” or “synthetic data record” may refer to a data record that does not correspond to a real event, individual, or observation. As an example, while a user data record may correspond to a real user of an image hosting service, an artificial data record may correspond to an artificial user of that image hosting service. Artificial data records can be generated based on real data records and can be used in many of the same contexts as real data records.

A “machine learning model” may refer to a file, program, software executable, instruction set, etc., that has been “trained” to recognize patterns or make predictions. For example, a machine learning model can take transaction data records as an input, and classify each transaction data record as corresponding to a legitimate transaction or a fraudulent transaction. As another example, a machine learning model can take weather data as an input and predict if it will rain later in the week. A machine learning model can be trained using “training data” (e.g., to identify patterns in the training data) and then apply this training when it is used for its intended purpose. A machine learning model may be defined by “model parameters,” which can comprise numerical values that define how the machine learning model performs its function. Training a machine learning model can comprise an iterative process used to determine a set of model parameters that achieve the best performance for the model.

“Noise” may refer to irregular, random, or pseudorandom data that can be added to a signal or data in order to obscure that signal or data. Noise may be added intentionally to data for some purpose, for example, visual noise may be added to images for artistic reasons. Noise may also exist naturally for some signals. For example, Johnson-Nyquist noise (thermal noise) comprises electronic noise generated by the thermal agitation of charge carriers in an electric conductor.

### BRIEF DESCRIPTION OF THE DRAWINGS

FIG. 1 shows a system block diagram summarizing an exemplary use case for some embodiments of the present disclosure.

FIG. 2 show some examples of data sets, data records, and conditional vectors according to some embodiments.

FIG. 3 shows a system block diagram of an exemplary artificial data synthesizer according to some embodiments.

FIG. 4 shows a flowchart corresponding to an exemplary method of synthesizing artificial data records according to some embodiments.

FIG. 5 shows a flowchart corresponding to an exemplary data pre-processing method according to some embodiments.

FIG. 6 shows a diagram of an exemplary multi-modal distribution, which can be used to assign categories to normalized data values.

FIG. 7 shows a diagram detailing an exemplary method of category combination according to some embodiments.

FIG. 8 shows a diagram detailing an exemplary method of assigning a single category to a data record associated with a combined category according to some embodiments.

FIGS. 9A-9B show a flowchart of an exemplary method for training a machine learning model to generate artificial data records in a privacy-preserving manner, according to some embodiments.

FIG. 10 shows an exemplary computer system according to some embodiments.

### DETAILED DESCRIPTION

As described above, embodiments are directed to methods and systems for synthesizing artificial data records in a privacy-preserving manner. In brief, a computer system or other device can instantiate and train a machine learning model to produce these artificial data records. As an example, this machine learning model could comprise a generative adversarial network (a GAN), an autoencoder (e.g., a variational autoencoder), a combination of the two, or any other appropriate machine learning model. The machine learning model can be trained using (potentially sensitive or private) data records to generate the artificial data records. After training, a trained “generator model” (or “generator sub-model”), which can comprise part of the machine learning model (e.g., part of a GAN), can be used to generate the artificial data records.

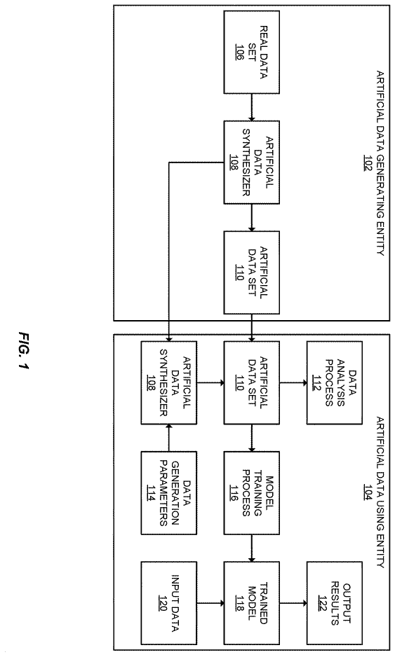

FIG. 1 shows a system block diagram that generally illustrates a use case for embodiments of the present disclosure. An artificial data generating entity 102 may possess a real data set 106, containing (potentially sensitive or private) data records. The real data set 106 could comprise, for example, private medical records corresponding to individuals. The real data set 106 can be subject to privacy rules or regulations preventing the transmission or publication of these data records. These data records may be potentially useful to an artificial data using entity 104, which may comprise, for example, a public health organization or a pharmaceutical company that wants to use the private medical records to research a cure or treatment for a disease. However, due to the aforementioned rules or regulations, the artificial data generating entity 102 may be unable to provide the real data set 106 to the artificial data using entity 104.

Instead, the artificial data generating entity 102 can use an artificial data synthesizer 108, which may comprise a machine learning model that is instantiated, trained, and executed by a computer system (e.g., a server computer, or any other appropriate device) owned and/or operated by the artificial data generating entity 102. This machine learning model could comprise, for example, a generative adversarial network (GAN), an autoencoder (such as a variational autoencoder) a combination of these two models, or any other appropriate machine learning model. Using the real data set 106 as training data, the artificial data synthesizer 108 can be trained to produce an artificial data set 110, which is generally representative of the real data set 106, but protects the privacy of the real data set 106.

Rather than sharing the real data set 106 with the artificial data using entity 104, the artificial data generating entity can transmit the artificial data set 110 to the artificial data using entity 104 or alternatively publish the artificial data set 110 in such a way that the artificial data using entity 104 is able to access the artificial data set 110. Alternatively, the artificial data generating entity 102 could transmit the trained artificial data synthesizer 108 itself to the artificial data using entity 104, enabling the artificial data using entity 104 to generate its own artificial data set 110, optionally using a set of data generation parameters 114.

As an example, the real data set 106 may correspond to user data records corresponding to users of an online streaming service that relies on advertising revenues. These data records could correspond to a variety of users belonging to a variety of demographics. The artificial data using entity 104 could comprise an advertising firm contracted by a company to advertise a product to women 35-45. This advertising firm could use data generation parameters 114 to instruct the artificial data synthesizer 108 to generate an artificial data set 110 corresponding to (artificial) women ages 35-45. The advertising firm could then look at this artificial data set 110 to determine which shows and movies those artificial women “watch”, in order to determine when to advertise the product.

The artificial data generating entity 102 and artificial data using entity 104 can each own and/or operate their own respective computer system, which may enable these two entities to communicate over a communication network (not picture), such as a cellular communication network or the Internet. However, it should be understood that such a communication network can take any suitable form, and may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers and devices in FIG. 1 (containing, for example, artificial data set 110 or artificial data synthesizer 108) may be transmitted using a communication protocol such as, but not limited to, File Transfer Protocol (FTP); Hypertext Transfer Protocol (HTTP); Secure Hypertext Transfer Protocol (HTTPS); Secure Socket Layer (SSL), ISO (e.g., ISO 8583) and/or the like.

After receiving or generating the artificial data set 110, the artificial data using entity 104 can use the artificial data set 110 as they wish, without risking exposing private data from the real data set 106. This could include performing arbitrary data analysis processes 112 (e.g., determining frequently watched shows for a certain demographic, as described above), or to train a machine learning model during a model training process 116. For example, the real data set 106 (and the artificial data set 110) could correspond to genetic data. A health organization may want to train a machine learning model (using the artificial data set 110) to detect genetic markers used to predict disease that may occur during an individual's lifetime. After training, the artificial data using entity 104 can provide input data 120 (e.g., a genetic sample of a baby or fetus) to the trained model 118 in order to produce an output result 122 (e.g., estimates of the likelihood of different diseases).

As described in more detail below; there is typically some risk that an artificial data synthesizer, such as artificial data synthesizer 108, inadvertently leaks information relating to the data used to train that model, such as data records from the real data set 106. For example, a generator model used to generate artificial user profiles (e.g., corresponding to a social network or a streaming service) may inadvertently learn to copy private information from the training data (e.g., the names or addresses of users) and may therefore inadvertently leak this private information. To address this, methods according to embodiments introduce several novel features that enable “differentially-private” training of the artificial data synthesizer 108 used to generate the artificial data set 110. In general, differential privacy refers to a specific mathematical definition of privacy related to the risk of data being exposed. These novel features may be better understood within the context of differential privacy, machine learning, and other related concepts. As such, it may be useful to describe such concepts before describing methods and systems according to embodiments in more detail.

### I. ARTIFICIAL DATA FOR PRIVACY IN MACHINE LEARNING

### A. Artificial Data

As stated above, artificial data can be useful in many of the same contexts as “real” data. For example, a movie recommender machine learning model can be trained to recommend movies based on the preferences of “artificial users” (represented by artificial data) instead of using real user data. Likewise, a machine learning model used to detect fraudulent credit card transactions can be trained using artificial transaction data instead of real transaction data. Artificial data are useful provided that the artificial data set is sufficiently representative of any corresponding real data set. That is, while a particular artificial data record preferably does not contain any data corresponding to a real data record (thereby preserving privacy), an entire artificial data set preferably accurately represent all data records collectively. This enables the artificial data set to be used for further data processing (such as training a machine learning model to identify risk factors for a disease, performing market analysis, etc.).

However, there is typically an implicit trade-off between privacy and “representativeness” of artificial data. Artificial data that is effective at preserving privacy is typically less representative. As an example, a machine learning model could generate random artificial data that is totally uncorrelated with any real data used to train that machine learning model. This artificial data cannot leak any information from the real data due to its uncorrelated randomness. However, it is also totally non-representative of the real data used to train the model. On the other hand, artificial data that is highly representative usually does not preserve privacy very well. As an example, a machine learning model could generate artificial data that is an exact copy of the real data used to train that machine learning model. Such artificial data would perfectly represent the real data used to generate it, and would be very useful for any further analysis. However, this artificial data does nothing to protect the privacy of the real data.

Private machine learning models can be designed with this tradeoff in mind. One strategy to overcome this tradeoff is determining an acceptable level of privacy or privacy risk, and then training the machine learning model to generate artificial data that is as representative as possible, while still conforming to the determined privacy level or privacy risk. To do so, techniques for quantifying privacy or privacy risk, such as differential privacy can be useful.

### B. Data Records and Tabular Data

Embodiments of the present disclosure are well suited to generating tabular data, particularly sparse tabular data. Tabular data generally refers to data that can be represented in a table form, e.g., an organized array of rows and columns of “fields,” “cells,” or “data values.” An individual row or column (or even a collection of rows, columns, cells, data values, etc.) can be referred to as a “data record.” Sparse data generally refers to data records for which most data values are equal to zero, e.g., non-zero data values are uncommon. Sparse data can arise when data records cover a large number of data values, some of which may not be applicable to all individuals or objects corresponding to those data records. For example a data record corresponding to personal property may have data fields for car ownership, boat ownership, airplane ownership, etc. Because most individuals do not own boats or airplanes, these data fields may often have a corresponding data value of zero. Some data representation techniques, such as “one hot encoding” may also result in sparse data.

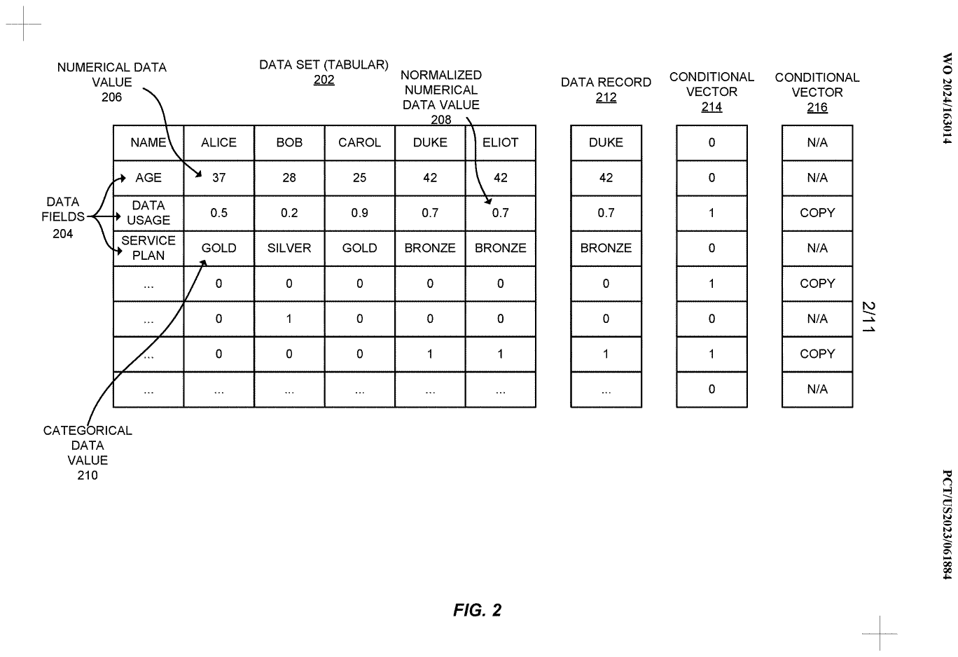

FIG. 2 shows an exemplary tabular data set 202, an exemplary data record 212, and two exemplary formulations of a conditional vector 214 and 216, which may be helpful in understanding embodiments of the present disclosure. The tabular data set 202 can comprise data corresponding to users of an internet service. The tabular data set 202 can be organized such that each column corresponds to an individual data record and each row corresponds to a particular data field in those data record columns. For example, exemplary data fields 204 can correspond to the age of users, a data usage metric, and a service plan category. The tabular data set 202 may comprise numerical data values 206, such as the actual age of the user (e.g., 37), as well as normalized numerical data values 208, such as the user's data usage normalized between the values 0 and 1. A normalized numerical data value 208 such as 0.7 could indicate that the user has used 70% of their allotted data for the month or is in the 70^{th} percentile of data usage. Additionally, data values may be categorical. For example, categorical data value 210 indicates the name or tier of the user's service plan, presumably from a finite set of possible service plans.

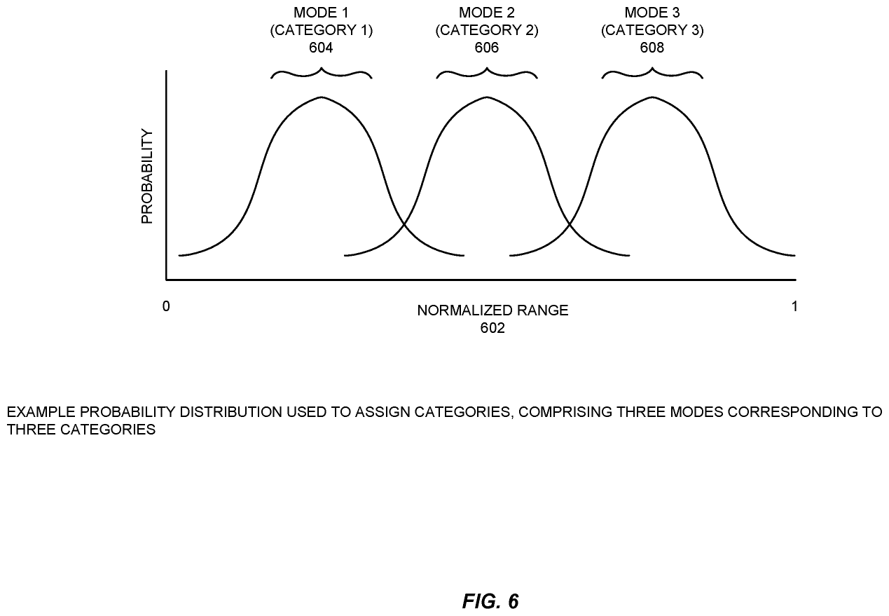

In some cases a data value can identify or be within a category. Categorical data value 210 “directly” identifies a service plan category (GOLD) out of a presumably finite number of possible categories (e.g., GOLD, SILVER, BRONZE). However, data values can also “indirectly” identify categories, e.g., based on a mapping between numerical data values (or normalized numerical data values) and categories. For example, a numerical data value 206 (Age=37) may correspond to (or be within) a category such as “adult” and a normalized numerical data value 208 (data usage=0.7) may correspond to (or be within) a category such as “high usage.” Categories can be determined from data values using any appropriate means or technique. One particular technique for determining or assigning categories to data values is the use of Gaussian mixture modelling, as described further below with reference to FIG. 6.

Throughout this disclosure, example categories are usually “semantic” categories, such as “child,” “teenager,” “young adult,” “adult,” “middle aged,” “elderly,” etc. However, it should be understood that these exemplary categories were chosen because they are generally easier for humans to understand, and it is relatively easy for humans to determine (for example) how a numerical data value such as age could be assigned to one of these particular categories. However, embodiments of the present disclosure can be practiced with any form of category and any means to identify category, and are not limited to such semantic categories. For example, a range of normalized data values, such as 0.1 to 0.5 could correspond to a particular category, while a different random of normalized data values (such as 0.51 to 0.57) could correspond to a different category. These categories do not need names or labels in order to exist.

Exemplary data record 212 can comprise a column of data from the tabular data set 202 corresponding to a particular user (e.g., Duke). Such data records can be sampled from the tabular data set and used as training data to train a machine learning model (e.g., the artificial data synthesizer 108 from FIG. 1) to generate artificial data records. As described in greater detail below, conditional vectors (such as conditional vectors 214 and 216) can be used for this purpose. A conditional vector 214 can be used to indicate particular data fields and data values to reproduce when generating artificial data records during training. A conditional vector can indicate these data fields in large number of ways, and the two examples provided in FIG. 2 are intended only as non-limiting examples. As one example, conditional vector 214 can comprise a binary vector in which each element has the value of 0 or 1. A value of 0 can indicate that a corresponding data value in a data record (e.g., data record 212) can be ignored during artificial data generation. A value of 1 can indicate that a corresponding data value in a data record should be copied during artificial data generation, in order to train the model to produce artificial data records that are representative of data records that contain that particular data value. Exemplary conditional vector 216 comprises a list of “instructions” indicating whether a corresponding data value can be ignored (“N/A”) or should be copied (“COPY”) during artificial data generation.

It should be understood that FIG. 2 illustrates only one example of a tabular data and is intended only for the purpose of illustration and the introduction of concepts or terminology that may be used throughout this disclosure. Embodiments of the present disclosure can be practiced or implemented using other forms of tabular data or data records. For example, instead of representing data records as columns and representing data fields as rows, a tabular data set could represent data records as rows and represent data fields as columns. A tabular data set does not need to be two dimensional (as depicted in FIG. 2), and can instead be any number of dimensions. Further, individual data values do not need to be numerical or categorical as displayed in FIG. 2. For example, a data value could comprise any form of data, such as data representative of an image or video, a pointer to another data table or data value, another data table itself, etc.

### C. Differential Privacy

Differential privacy refers to a rigorous mathematical definition of privacy, which is summarized in broad detail below. More information on differential privacy can be found in [1]. With differential privacy, the privacy of a method or process [symbol] can be characterized by one or two privacy parameters: ε (epsilon) and δ (delta). These privacy parameters generally relate to the probability that information from a particular data record is leaked during the method or process [symbol] . Typically, smaller values of ε and δ result in greater privacy guarantees, at the cost of reduced accuracy or representativeness, while large values of ε and δ result in the opposite.

Differential privacy can be particularly useful because the privacy of a process can be qualified independently of the data set that process is operating on. In other words a particularly (ε,δ) pair generally has the same meaning regardless of if a process is being used to analyze healthcare data, train a machine learning model to generate artificial user accounts, etc. However, different values of ε and δ may be appropriate or desirable in different contexts. For data that is very sensitive (e.g., the names, living addresses, and social security numbers of real individuals) very small values of ε and δ may be desirable, as the consequences of leaking such information can be significant. For data that is less sensitive (e.g., hours of movies streamed in the past week), larger values of ε and δ may be acceptable.

In a general sense, a method or process [symbol] (which takes a data set as an input) is differentially-private if by looking at the output of the process [symbol] , it is not possible to determine whether a particular data record was included in the data set input to that process. Differential privacy can be qualified based on two hypothetical “neighboring” data sets d and d′, one which contains a particular data record and one which does not contain that particular data record. A method or process [symbol] is differentially-private if the outputs [symbol] (d) and [symbol] (d′) are similar or similarly distributed. The more similar (or similarly distributed) the two outputs are, the greater the privacy is. If the two outputs are identical or identically distributed, it may be impossible to distinguish which data set d or d′ was used as an input to the process [symbol] . As such, it may be impossible to determine if the particular data record was an input to the process [symbol] , thereby preserving the privacy of that particular data record (or, e.g., an individual associated with that data record).

More technically, a method [symbol] : [symbol] → [symbol] with domain [symbol] and range [symbol] satisfies (ε,δ)-differential privacy if for any two adjacent inputs d, d′∈ [symbol] and for any subset of outputs S⊆ [symbol] it holds that: Pr[ [symbol] (d)∈S]≤e^{ε}*Pr[ [symbol] (d′)∈S]+δ.

Based on this formula, it can be shown that as ε and/or δ increases, it becomes easier to satisfy the inequality, regardless of the particular distribution of outputs for [symbol] (d) and [symbol] (d′). On the other hand, for ε=0 and δ=0, the inequality requires the stricter condition that Pr[ [symbol] (d)∈S]≤Pr[ [symbol] (d′)∈S]. As such, lower values of ε and δ typically correspond to stricter privacy requirements, while higher values of ε and δ typically correspond to less strict privacy requirements.

In the context of embodiments, the hypothetical method or process [symbol] is analogous to the process for training the machine learning model used to generate artificial data records. The output [symbol] (d)∈S can comprise the trained model (and by extension, artificial data records generated using the trained model) and the input d can comprise the (potentially sensitive or private) data records used to train the machine learning model. Parameters ε and δ can be chosen so that the risk of the trained model leaking information about any given training data record are acceptably low.

### 1. Implementing Differential Privacy

In general, differential privacy can be implemented by adding noise (e.g., random numbers) to processes that are otherwise not differentially-private (and which may be deterministic). Provided the noise is large enough, it may be impossible to determine the “deterministic output” of the process based on the noisy output, thereby preserving differential privacy. The effect of preserving privacy through the adding noise is illustrate by the following example. In this example, an individual could query a “private” database to determine the average income of 10 people (e.g., $50,000), including a person named Alice. While this statistic alone is insufficient to determine the income of any individual person (including Alice), the individual could query the database multiple times to learn Alice's income, thereby violating Alice's privacy. For example, the individual could query the database to determine the average income of 9 people (everyone but Alice, e.g., $45,000), then use the difference between the two results to determine Alice's income ($95,000) thereby violating Alice's privacy.

But if sufficient noise is added to the average income statistics, it may no longer be possible to use this technique to determine Alice's income, thereby preserving Alice's privacy. If for example, between −$5000 and $5000 of random noise was added to each of these statistics, Alice's calculated income could be anywhere between $0 and $190,000, which does not provide much information about Alice's actual income. At the same time, adding between −$5000 and $5000 of noise only distorts the average income statistics by at most approximately 11.2%, meaning the statistic is still fairly representative of the actual average income.

Much like how noise was added during this database query example to achieve differential privacy, noise can also be added while training a machine learning model in order to achieve differential privacy. This process is summarized in some detail below, and is described in greater detail in [2]. However, before describing differentially-private machine learning, it may be useful describe some machine learning concepts in greater detail.

### D. Machine Learning Models

This section describes some machine learning concepts at a high level and is intended to orient the reader, as well as introduce some terminology that may be used throughout the disclosure (such as “model parameters”, “noisy discriminator update values”, etc.). However, it is assumed generally that a person of skill in the art is already familiar with these concepts in some capacity (excluding those related to novel aspects of embodiments). As an example, it is assumed that a person of skill in the art understands what is meant by a statement such as “the weights of the neural network can be updated using backpropagation,” or “the gradients can be clipped prior to updating the model parameters” without needing a detailed explanation of how backpropagation or gradient clipping is performed.

As a high level overview, machine learning models can be characterized by “model parameters,” which determine, in part how the machine learning model performs its function. In an artificial neural network for example, model parameters might comprise neural network weights. Two machine learning model that are identical except for their model parameters will likely produce different outputs. For example, two artificial data generators with different model parameters may produce different artificial data records. Broadly, training machine learning models can involve an iterative training process used to refine or optimize the model parameters that define the machine learning model.

In each round of training, “model update values” can be determined based on the performance of the model, and these model update values can be used to update the model parameters. For a neural network for example, these model update values could comprise gradients used to update the neural network weights. These model update values can be determined, broadly, by evaluating the current performance of the model during each training round. “Loss values” or “error values” can be calculated that correspond to the difference between the model's expected or ideal performance and its actual performance. For example, a binary classifier machine learning model can learn to classify data as belonging to one of two classes (e.g., legitimate and fraudulent). If the binary classifier's training data is labeled, a loss or error value can be determined based on the difference between the machine learning model's classification and the actual classification given by the label. If the binary classifier correctly labels the training value, the loss value may be small or zero. If the binary classifier incorrectly labels the training value, the loss value may be large. Generally for classifiers, the more similar the classification and the label, the lower the loss value can be.

Such loss values can be used to generate model update values that can be used to update the machine learning model parameters. In general, for the purpose of this explanation, it is assumed that large model update values can result in a large change in machine learning model parameters, while small model update values can result in a small change in machine learning model parameters. If the loss values are low or zero, it May indicate that the model parameters are generally effective for whatever task the machine learning model is learning to perform. As such, the model update values may be small. If the loss values are large, it may indicate that the machine learning model is not performing well at its intended task, and a large change may be needed to the model parameters. As such, the model update values may be large.

A “terminating condition” can define the point at which training is complete and the model can be validated and/or deployed for its intended purpose (e.g., generating artificial data records). Some machine learning systems are configure to train for a specific number of training rounds or epochs, at which point training is complete. Some other machine learning systems are configured to train until the model parameters “converge,” i.e., the model parameters no longer change (or change only slightly) in successive training rounds. A machine learning system may periodically check if the terminating condition has been met. If the terminating condition has not been met, the machine learning system can continue training, otherwise the machine learning system can terminate the training process. Ideally, once training is complete, the trained model parameters can enable the machine learning model to effectively perform its intended task.

### 1. Generative Adversarial Networks

Some embodiments of the present disclosure can use generative adversarial networks (GANs) to generate artificial data records. One advantage of GANs over other data generation models is that using GANs generally does not require any expert knowledge of the underlying training data. GANs may be better understood with reference to [3], but are summarized below in order to orient the reader. A GAN typically comprise two sub-models: a generator sub-model and a discriminator sub-model. For a GAN, “model parameters” may refer to both a set of “generator parameters” that define the generator sub-model and a set of “discriminator parameters” that define the discriminator sub-model. In broad terms, the role of the generator can be to generate artificial data. The role of the discriminator can be to discriminate between artificial data generated by the generator and the training data. Generally, training a GAN involves training these two sub-models roughly simultaneously. Generator loss values and discriminator loss values can be used to determine generator update values (used to update the generator parameters in order to improve generator performance) and discriminator update values (used to update the discriminator parameters in order to improve discriminator performance).

The generator loss values and discriminator loss values can be based on the performance of the generator and discriminator at their respective tasks. If the generator is able to successfully “deceive” the discriminator by generating artificial data that the discriminator cannot identify as artificial, then the generator may incur a small or zero generator loss value. The discriminator however, may incur a high loss value for failing to identify artificial data. Conversely, if the generator is unable to deceive the discriminator, the generator may incur a large generator loss, and the discriminator may incur a low or zero loss due to successful identification of the artificial data.

In this way, the discriminator puts pressure on the generator to generate more convincing artificial data. As the generator improves at generating the artificial data, it puts pressure on the discriminator to better differentiate between real data and artificial data. This “arms race” eventually culminates in a trained generator that is effective at generating convincing or representative artificial data. This trained generator can then be used to generate an artificial data set which can be used for some purpose (e.g., analysis without violating privacy rules, regulations, or legislature).

### 2. Differential Privacy and Machine Learning

As described above, differential privacy is generally achieved by adding noise to methods or processes. To achieve differential privacy in machine learning models, noise can be added to the model update values during each round of training. For example, for a neural network, gradients can be calculated using stochastic gradient descent. Afterwards, the gradients can be clipped and noise can be added to the clipped gradients. This technique is described in more detail in [2] and is proven to be differentially-private.

While added noise generally reduces a model's overall accuracy or performance, it has the benefit of improving the privacy of the trained model. Such noise limits the effect of individual training data records on the model parameters, which in turn reduces the likelihood that information related to those individual training data records will be leaked by the trained model. Gradient clipping works in a similar manner to achieve differential privacy. In general, for neural network based machine learning models, gradient clipping involves setting a maximum limit on any given gradient used to update the weights of the neural network. Limiting the gradients has the effect of reducing the impact of any particular set of training data on the model's parameters, thereby preserving the privacy of the training data (or individuals or entities corresponding to that training data).

In many GAN architectures, the generator either receives no input at all, or receives a random or pseudorandom “seed” used to generate artificial data. As such, the generator does not “directly” risk exposing private data during a training process, as it does not usually have access to the training data. However the discriminator does use the training data in order to discriminate between artificial data (generated by the generator) and the real training data. Because the generator loss values (and therefore the generator update values and generator parameters) are based on the performance of the discriminator, the generator can inadvertently violate privacy via the discriminator. Embodiments can address this issue by adding noise to the discriminator update values (e.g., discriminator gradients) and optionally clipping the discriminator update values. While noise can optionally be added to the generator update values, it is not necessary because the discriminator typically has access to the (potentially sensitive or private) training data (not the generator), and therefore adding noise to the discriminator update values is sufficient to achieve differential privacy.

### E. Minority Data Representation

One general challenge with artificial data generation systems is accurately representing a corresponding real data set, including accurate representation of minority data records. Some differentially-private GAN systems (such as those described in [4]) have difficulty with minority data representation along with sparse data representation. Embodiments however use “conditional vectors” (described in more detail below) to provide for better minority data representation in artificial data records.

A minority data record generally refers to a data record that has data characteristics that are rare or are otherwise inconsistent with the “average” data record in a data set. Generally artificial data generators typically do a good job at generating artificial data that is representative of average data. This is because machine learning models are typically evaluated using loss values that relate to the difference between an expected or ideal result (e.g., a real training data record) and the result produced by the generator system (e.g., the artificial data record). Generating artificial data records that are similar to the average data record is generally effective at minimizing such loss values. As such, this behavior is often inadvertently learned by machine learning models.

However, minority data records are (by definition) different from the majority data records, and are therefore different than the average data record. As such many machine learning models generally do poorly at generating artificial data records corresponding to minority data records, but because such data records are rare by their nature, they usually do not have a large effect on model update values and trained model parameters, and hence such models do not learn how to generate minority data records.

This can be problematic in applications involving the detection of minority data instances. An example is detecting credit card fraud. Because most credit card transactions are legitimate, fraudulent credit card transactions comprise a very small minority. However, data analysts are much more interested in identifying fraudulent transactions than legitimate credit card transactions. A fraudulent credit card transaction using requires some rectification, e.g., the transaction should be cancelled or reversed, the card should be deactivated, etc. This is in contrast to a legitimate credit card transaction, which usually does not require such rectification, and usually does not need to be detected. Because of the rarity of fraudulent credit card transactions, a generator trained to produce artificial credit card transaction data may inadvertently produce an artificial data set that contains no fraudulent transactions. This is problematic because such an artificial data set may not be useful for any further analysis or processing (e.g., training a machine learning model to detect fraudulent credit card transactions).

1. Improving Minority Data Representation using Conditional Vectors

One technique to improve minority data representation is the use of “conditional vectors” (also referred to as “mask vectors”) in model training. The use of conditional vectors is described in more detail in [5], which proposes a “conditional tabular GAN” (or “CTGAN”), a GAN system that uses conditional vectors to improve minority data representation. However, while CTGAN uses conditional vectors to improve minority data representation, it does not guarantee differential privacy (unlike embodiments of the present disclosure).

The use of conditional vector is generally summarized below. In general, a conditional vector defines a condition applied to artificial data generated by the generator. This can involve, for example, requiring the generator to generate an artificial data record with particular characteristics or a particular data feature, or alternatively “encouraging” or “punishing” (e.g., based on a small or large loss value) a generator for generating artificial data records with or without those characteristics or data features. In this way, training can be better controlled. In a system in which data records are sampled completely at random for training, the sampling rate of minority data records is proportional to the minority population within the overall training data set, and therefore the generator may only generate minority artificial data records proportional to this small population. But by using conditional vectors, it is possible to control the frequency at which the generator generates artificial data records belonging to particular classes or categories during training. If 10% of conditional vectors specify that the generator should generate artificial data records corresponding to minority data, then the generator may generate artificial data records at that 10% rate, rather than based on the actual proportion of minority data records within the training data set. As such, using conditional vectors can result in higher quality artificial data records that are well-suited for sparse data and for preserving minority data representation.

### 2. Conditional Vector Privacy Concerns

Embodiments of the present disclosure provide for some techniques to provide differential privacy when using conditional vectors. As described above, conditional vectors can be used to force or incentivize a machine learning model to generate artificial data records with particular characteristics, such as minority data characteristics. In this way, the machine learning model can learn to generate artificial data records that are representative of the data set as a whole, rather than just majority data. As an example, users of a streaming service may generally skew towards younger users, however there may be a minority of older users (e.g., 90 years old or older). A machine learning model (that does not use conditional vectors) may inadvertently learn to generate artificial user data records corresponding to younger users, and never learn to generate artificial user data records corresponding to older users. However, by using conditional vectors, the machine learning model could be forced during training to learn how to generate artificial data records corresponding to older users, and therefore learn how to better represent the input data set as a whole.

However, conditional vectors create unique challenges for achieving differential privacy. In machine learning contexts, differential privacy is related to the frequency at which a particular data record is sampled and used during training. If a data record (or a data value contained in that data record) is used more often in training, there is greater risk to privacy. For majority data records this is less of an issue, because there are a large number of majority data records, and therefore the probability of sampling any particular data record is low. But because conditional vectors encourage the machine learning model to generate artificial data corresponding to minority data records, they can increase the probability that minority data records are used in training. Because there are generally fewer minority data records, the probability of sampling any given minority data record increases. For example, if there are only ten users who are 90 years old or older, there is a 10% chance of sampling any given user, when sampling from that subset of users. As such, there is a greater risk of the trained model learning private information corresponding to specific minority data records and inadvertently divulging private information in a generated artificial data set.

### F. Differentially-Private Conditional Vectors

Embodiments of the present disclosure involve some novel techniques that can be used to address the privacy concerns described above. One such technique is “category combination.” As described above, by using conditional vectors to “encourage” a machine learning model to learn to generate accurate artificial data records corresponding to minority data, the machine learning model has a greater chance of sampling or using data from any particular data record, risking the privacy of that data record. Category combination can be used to reduce the probability of sampling or using any particular data record in training, and can therefore decrease the privacy risk and enable embodiments to guarantee differential privacy.

In short, an artificial data synthesizer (e.g., a computer system) can count the number of training data records that correspond to identified categories. For example, an artificial data synthesizer can count the number of training data records that correspond to “young” users of a streaming service, “middle aged” users, “old” users, etc. A category with “too few” corresponding data records (e.g., less than a predetermined limit) may correspond to minority data, and may pose a greater privacy risk. If the artificial data synthesizer determines that a category is “deficient” (e.g., contains less than a minimum number of corresponding data records), the artificial data synthesizer can merge that category with one or more other categories. For example, if there are too few “old” users of a streaming service, the artificial data synthesizer can merge the “old” and “middle aged” categories into a single category.

As such, when using conditional vectors to train the machine learning model, rather than encouraging the machine learning model to generate artificial data records corresponding to “old” users (for example), the conditional vectors can instead instruct the machine learning model to generate artificial data records corresponding to users in the combined “old and middle aged” category. Since this combined category is larger than the “old” category, the probability of sampling data from any particular data record is reduced, and thus the privacy risk is reduced.

### 1. Differential Privacy and Counting

As described above, differential privacy is a strong mathematical privacy guarantee, based off the probability that an output of a method or process [symbol] reveals that a particular data record is included in a data set that was an input to that process [symbol] . Generally, differential privacy is “stricter” than human interpretations of the meaning of privacy. As a result, it is possible for a process to fail to provide differential privacy in ways that may be unintuitive. One such example is counting. When human users think of privacy leaks, they usually think of their personally identifying information (e.g., name, social security number, email address, etc.) being exposed. The do not usually think of a count of users of that service, e.g., 123,281,392 somehow comprising a privacy leak. However, such counts generally violate the rules of differential privacy, as illustrated below.

Consider two neighboring data sets d and d′, which are identical except that one contains a particular data record and one does not contain that particular data record. If a method or process [symbol] were to count the number of data records in each data set d and d′, it would produce two different counts, as each data set contains a different number of data records. As such, this method or process [symbol] would not satisfy differential privacy, as the outputs of the process applied to both data sets are not similar or similarly distributed. In this way, counting categories in order to determine if those categories should be combined (as described above) risks violating differential privacy.

As such, in order to guarantee differential privacy, embodiments of the present disclosure can use noisy category counts to evaluate whether categories are deficient (e.g., contain too few data records). These noisy category counts can comprise a sum of a category count (e.g., the actual number of data records belonging to a particular category) and a category noise value (e.g., a random number). Because of the added category noise, it may not be possible to determine whether a particular data record was included in the count for a particular category, and therefore these category counts no longer violates differential privacy. This is similar, generally, to the database income example provided above, in which adding noise to the average income of some number of individuals protects the privacy of a particular individual (e.g., Alice) whose income was used to calculate the average income statistic.

### II. SYSTEM DIAGRAM

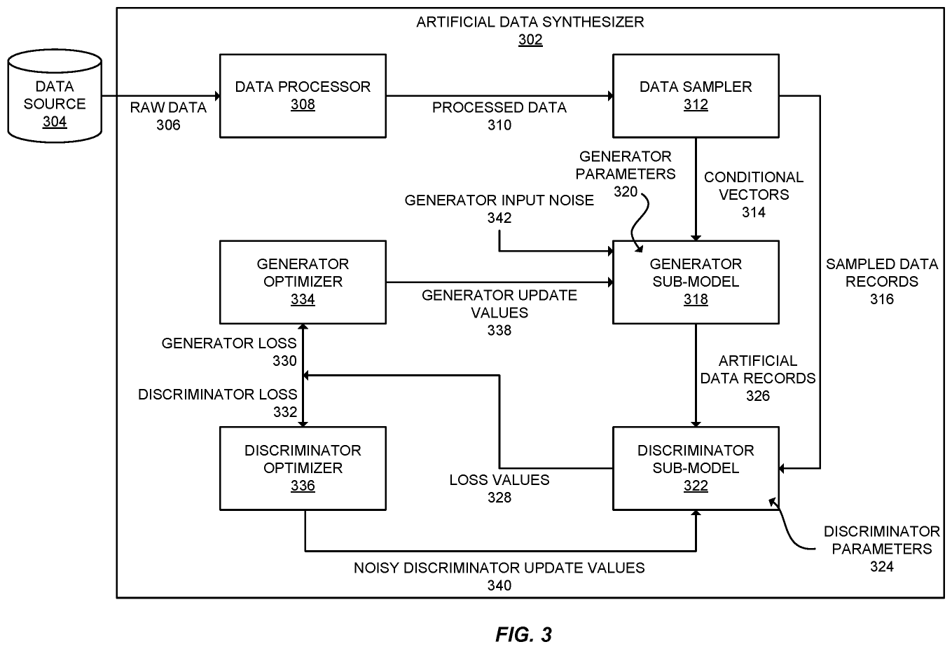

FIG. 3 shows a diagram of an artificial data synthesizer 302 according to some embodiments of the present disclosure, along with a data source 304. The artificial data synthesizer 302 can comprise several components, including a generative adversarial network (GAN). A generator sub-model 318, discriminator sub-model 322, generator optimizer 334, and discriminator optimizer 336 may be components of this GAN. The artificial data synthesizer 302 can additionally comprise a data processor 308 and a data sampler 312, which can be used to process or pre-process data records (retrieved from the data source 304) used to train the GAN. Once the GAN is trained, the artificial data synthesizer 302 can use the generator sub-model 318 to generate artificial data records.

The artificial data synthesizer 302 components illustrated in FIG. 3 are intended primarily to explain the function of the artificial data synthesizer and methods according to embodiments, and are not intended to be a limiting depiction of the form of the artificial data synthesizer 302. As an example, although FIG. 3 depicts a separate data processor 308 and a data sampler 312, the data processor 308 and data sampler 312 could comprise a single component. The artificial data synthesizer 302 can comprise a computer system or can be implemented by a computer system. For example, the artificial data synthesizer 302 could comprise a software application or executable executed by a computer system. Each component of the artificial data synthesizer could comprise a physical device (e.g., the data processor 308 and the data sampler 312 could comprise separate devices connected by some interface) or could comprise a software module. In some embodiments, the artificial data synthesizer 302 can be implemented using a monolithic software application executed by a computer system.

In summary terms, the artificial data synthesizer 302 can retrieve data records (depicted in FIG. 3 as “raw data” 306 from a data source 304. This data source 304 can comprise, for example, a database, a data stream, or any other appropriate data source. The raw data 306 may have several typically undesirable characteristics. For example, raw data 306 may comprise duplicate data records, erroneous data records, data records that do not conform to a particular data format, outlier data records, etc. The artificial data synthesizer 302 can use data processor 308 to process raw data 306 to address these undesirable characteristics, thereby producing processed data 310. This processed data 310 can be sampled by data sampler 312 and used to train the GAN to produce artificial data records.

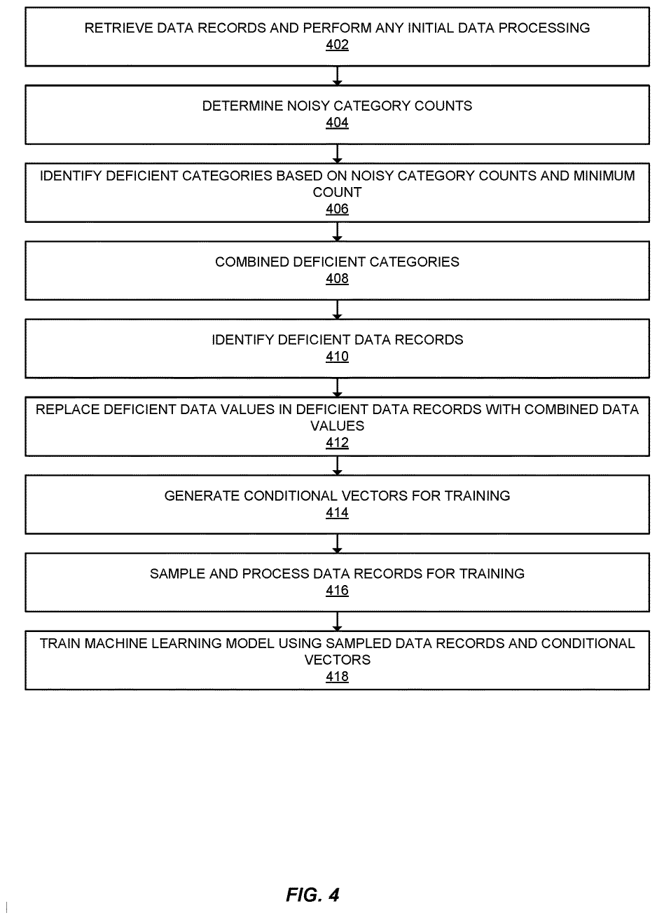

Specific data processing (or data pre-processing; the terms are used largely interchangeably herein) operations are described in more detail below with reference to FIGS. 4-7. These data processing operations can include data pre-processing steps such as data validation, data cleaning, removing outliers, etc., as well as specific data processing steps that enable the generation of privacy-preserving artificial data records. As a brief summary, these steps can include (1) identifying and removing non-sparse data records, (2) normalizing numerical data values. (3) assigning categories to normalized numerical data values, (4) counting the number of data records corresponding to each category, (5) identifying any deficient categories, (6) combining deficient categories, and (7) updating data records to identify combined categories. These steps are described in more detail further below. Some of these steps were described and motivated in Section I above. For example, deficient categories may be combined in order to reduce the probability that any particular data record or data value is sampled during training, thereby reducing privacy risk.

The data sampler 312 can sample data records 316 from the processed data 310 to use as training data. This training data can be used to train the GAN to generate artificial data records. The data sampler 312 can also generate conditional vectors 314. These conditional vectors 314 may be used to encourage the generator sub-model 318 to generate artificial data records 326 that have certain characteristics or data values. For example, data records contained in processed data 310 may correspond to users of a streaming service. Such user data records may comprise a data field corresponding to the age of the user, and users may be categorized by the data value corresponding to this data field. Some users may be characterized as “young adults”, other users may be categorized as “adults”, “middle-aged adults”, “elderly”, etc. The conditional vectors 314 can be used to make the generator sub-model 318 generate artificial data records 326 corresponding to each of these categories, in order to train the generator sub-model 318 to generate artificial data records 326 that are more representative of the processed data 310 as a whole.

In some cases, the conditional vectors 314 may identify particular data fields corresponding to the sampled data records 316 that the generator sub-model 318 should replicate when generating artificial data records 326. For example, if a sampled data record 316 has a data field indicating that a corresponding user is “elderly”, the generator sub-model 318 may generate an artificial data record 326 that also contains a data field indicating that an “artificial user” corresponding to that artificial data record 326 is “elderly.” This may be useful if there is a small minority proportion of elderly users.

During training, these conditional vectors 314 and sampled data records 316 can be partitioned into batches. Over a course of a number of training rounds, the generator sub-model 318 can use this data, along with a generator input noise 342 (e.g., a random seed value, sampled from a distribution unrelated to the processed data 310) to generate artificial data records 326 corresponding to each training round. These artificial data records 326 along with any corresponding sampled data records 316 can be provided to the discriminator sub-model 322, without an indication of which data records are artificial and which data records are sampled.

The discriminator sub-model 322 can attempt to identify the artificial data records 326 by comparing them to the sampled data records 316 in the batch. Based on this comparison, loss values 328, including a generator loss value 330 and a discriminator loss value 332 can be determined. As described in Section I, these loss values 328 can be based on the discriminator sub-model's 322 ability to identify artificial data records 326. For example, if the discriminator sub-model 322 correctly identifies the artificial data records 326 with a high degree of confidence, the discriminator loss value 332 may be small, while the generator loss value 330 may be large.

The generator loss value 330 and discriminator loss value 332 can be provided to a generator optimizer 334 and a discriminator optimizer 336 respectively. The generator optimizer 334 can use the generator loss value 330 to determine one or more generator update values 338, which can be used to update generator parameters 320, which may characterize the generator sub-model 318. As an example, the generator sub-model 318 can be implemented using a generator artificial neural network, and the plurality of generator parameters can comprise a plurality of generator weights corresponding to the generator artificial neural network. In this case, the generator optimizer 334 can use stochastic gradient descent to determine generator update values 338 comprising gradients. These gradients can be used to update the generator weights, e.g., using backpropagation.

In a similar manner, the discriminator optimizer 336 can use the discriminator loss value 330 to determine noisy discriminator update values 340, which can be used to update discriminator parameters 324 that characterize the discriminator sub-model 322. However, the discriminator optimizer 336 may perform some additional operations in order to guarantee differential privacy. As an example, the discriminator optimized 336 can generate initial discriminator update values (e.g., gradient discriminator update values without noise), then clip these initial discriminator update values. Afterwards, the discriminator optimizer 336 can add noise to the initial discriminator update values to generate the noisy discriminator update values 340, which can then be used to update the discriminator parameters 324. As an example, the discriminator sub-model 322 can be implemented using a discriminator artificial neural network, and the plurality of discriminator parameters 324 can comprise a plurality of discriminator weights corresponding to the discriminator artificial neural network. In this case, the noisy discriminator update values 340 can comprise one or more noisy discriminator gradients which can be used to update the discriminator weights, e.g., using backpropagation.

This training process can be repeated over a number of training rounds or epochs. In each training round, new conditional vectors 314 and new sampled data records 316 can be used to generate the artificial data records 326, loss values 328, and model update values, resulting in updated generator parameters 320 and discriminator parameters 324. In this way, training improves the generator sub-model's 318 ability to generate convincing or representative artificial data records 326 and improves the discriminator sub-model's 322 ability to identify artificial data records 326. This training process can be repeated until a terminating condition has been met. For example, a terminating condition could specify a specific number of training rounds (e.g., 10,000), and once that number of training rounds have been performed, the training process can be complete. The artificial data synthesizer 302 can periodically check to see if the terminating condition has been met. If the terminating condition has not been met, the artificial data synthesizer 302 can repeat the iterative training process, otherwise the artificial data synthesizer 302 can terminate the iterative training process.

Once training is complete, the trained generator sub-model 318 can be used to generate a privacy-preserving artificial data set, which can be, e.g., published or transmitted to a client computer. Alternatively, the generator sub-model 318 itself can be published or transmitted to a client computer, enabling entities (such as the artificial data using entity 104 from FIG. 1) to generate artificial data sets as they see fit. Notably, although FIG. 3 depicts an artificial data synthesizer 302 comprising a GAN, other model architectures are also possible, such as autoencoders, variational autoencoders (VAEs), or transformations or combinations thereof.

### III. PRE-PROCESSING MODEL TRAINING DATA

FIG. 4 shows a flowchart for a method for training a machine learning model to generate a plurality of artificial data records (sometimes referred to as an “artificial data set”) in a privacy-preserving manner. This method can be performed by a computer system implementing an artificial data synthesizer (e.g., artificial data synthesizer 302 from FIG. 3).

### A. Retrieving and Initial Data Processing

At step 402, the computer system can retrieve a plurality of data records from a data source (e.g., a database or a data stream) and perform any initial data processing operations. Each data record can comprise a plurality of data values corresponding to a plurality of data fields. Each data value can identify or be within a category of a plurality of categories. As an example, a data record corresponding to a restaurant may have a “popularity” data value, such as 0.9, indicating it is in the 90^{th} percentile for restaurant popularity within a given location. This popularity data value can be within or otherwise indicate a category such as “very popular” out of a plurality of categories such as “unpopular”, “mildly popular”, “popular”, “very popular”, etc.

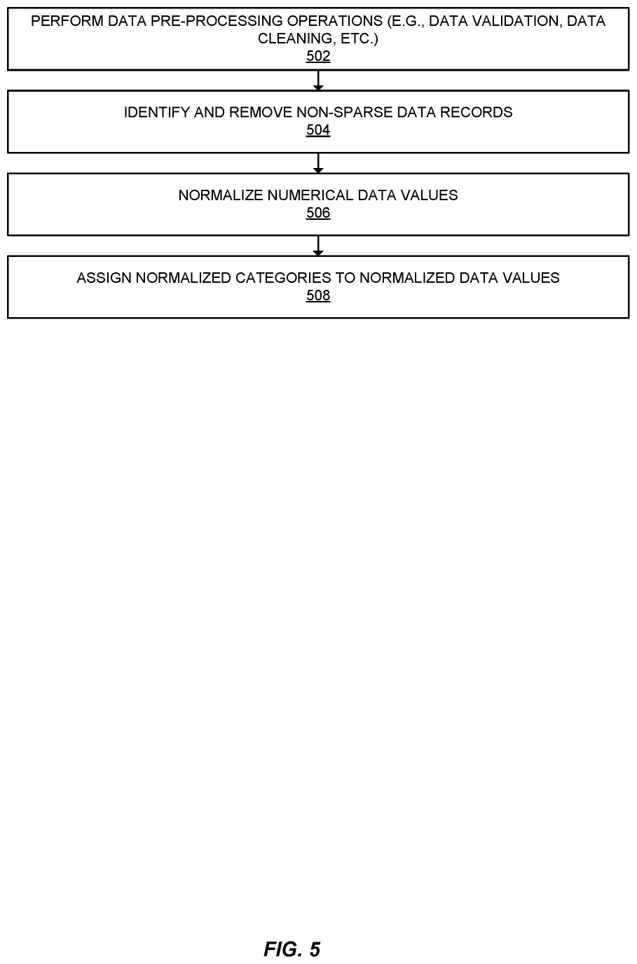

The initial processing can be accomplished using a data processor component, such as data processor 308 from FIG. 3. It can include a variety of processing functions, which are described in more detail with reference to FIG. 5.

At step 502, the computer system can perform various data pre-processing operations on the plurality of data records. For example, these can include “data validation” operations, e.g., operations used to verify that data records are valid (e.g., conform to a particular format or contain more or less than a specific amount of data (e.g., more than 1 KB, less than 1 GB, etc.)), as well as “data cleaning” or “data cleansing” operations, which can involve removing incomplete, inaccurate, incorrect, or erroneous data records from the plurality of data records prior to any further pre-processing or training the machine learning model. Additionally, data records that correspond to identifiable outliers can also be removed from the plurality of data records. These examples are intended to be illustrative, and are not intended to provide an exhaustive list of every operation that can be performed on the data records prior to further processing.

At step 504, the computer system can identify and remove non-sparse data records from the plurality of data records. These non-sparse data records may comprise outliers or may have increased privacy risk. For each data record of the plurality of data records (retrieved, e.g., at step 402 of FIG. 4), the computer system can determine if that data record has more than a maximum number of non-zero data values. Then for each data record that contains more than the maximum number of non-zero data values, the computer system can remove that data record from the plurality of data records, preventing these outlier data records from being used in later training.

This maximum number of non-zero data values can be predetermined prior to executing the training method described with reference to FIGS. 4 and 5. Alternatively, a privacy analysis can be performed in order to determine a maximum number of non-zero data values corresponding to a particular set of privacy parameters (ε,δ). For example, for lower values of (ε,δ) corresponding to stricter privacy requirements, the maximum number of non-zero data values may be lower than for higher values of (ε,δ). The relationship between privacy parameters (ε,δ) and hyperparameters of the machine learning process (including, for example, the maximum number of non-zero data values) can be complex, and in some cases cannot be represented by a simple closed formulation. In such cases, privacy analysis can enable the computer system (or, e.g., a data analyst operating the computer system) to determine a maximum number of non-zero data values that achieves a desired level of differential privacy.

As described above, embodiments of the present disclosure can use conditional vectors to preserve minority data representation, and therefore generate more representative artificial data. However as described above, using conditional vectors to improve minority data representation can cause additional privacy risk, as this technique increases the rate at which minority data values may be sampled in training. Embodiments address this by combining minority categories with other categories, which can reduce the probability of sampling any particular data record or data value during training. In order to do so, categories can be determined for particular data values, in order to determine which data values and data records correspond to minority categories. The computer system can perform a two-step process (steps 506 and 508) in order to determine or assign categories to data values.

At step 506, the computer system can normalize any non-normalized numerical data values in the plurality of data records. For each data record of the plurality of data records, the computer system can normalize one or more data values between 0 and 1 inclusive (or any other appropriate range) thereby generating one or more normalized data values. As an example, a data record corresponding to a golf player may contain data values corresponding to their driving distance (measured in yards), driving accuracy (a percentage), and average ball speed (measured in meters per second). The numerical driving distance data value and average ball speed data value may be normalized to a range of 0 to 1. The driving accuracy may not need to be normalized, as percentages are typically already normalized data values. Normalized data values may be easier to assign categories (e.g., in step 508 described below) to than non-normalized data values due to their defined range.

At step 508, the computer system can assign normalized categories to each of the normalized numerical data values. For example, for a normalized numerical data value corresponding to a golfer's driving distance, a “low” drive distance category, a “medium” drive distance category, or a “long” drive distance category can be assigned. These normalized categories can be included in a plurality of categories already determined or identified by the computer system. For example, perhaps these categories can be included among already determined categories such as “amateur,” “semi-professional,” and “professional,” or any other determined categories.

In more detail, the computer system can determine a plurality of normalized categories for each normalized numerical data value of the one or more normalized data values, based on a corresponding probability distribution of one or more probability distributions. Each probability distribution can correspond to a different normalized numerical data value of the one or more normalized numerical data values. In some cases, these probability distributions can comprise multi-modal Gaussian mixture models. An example of such a distribution is illustrated in FIG. 6. Such a probability distribution can comprise a predetermined number (m) of equally weighted modes.

FIG. 6 shows three such modes (mode 1 604, mode 2 606, and mode 3 608) distributed over the normalized range corresponding to a normalized data value. Each mode can correspond to a Gaussian distribution, with (for example) a mean equal to its respective mode and standard deviation equal to the inverse of the number of modes (1/m). Each mode can further correspond to a category, such that for each normalized category of the plurality of normalized categories there is a corresponding mode of the plurality of equally weighted modes. In other words, the number of normalized categories may be equal to the number of equally weighted modes. In FIG. 6 for example, because there are three modes 604-608, a normalized data value corresponding to this probability distribution may be assigned to one of three categories. For example, a golfer's normalized drive distance may be assigned to a category such as low, medium, or high, based on its value.

The computer system can use any appropriate method to assign a normalized data value to a normalized category using such a probability distribution. For example, the computer system could determine a distance between a particular normalized data value and each mode of the plurality of equally weighted modes, then assign a normalized data value to a category corresponding to the closest mode. For example, in FIG. 6, a normalized data value close to 0.5 could be assigned to category 2 606, while a normalized numerical data value corresponding to 0.9 could be assigned to category 3 608.

The use of gaussian mixture models with equally weighted modes may not perfectly represent the actual distribution of categories in data records. For example, for a streaming service, a majority of users may be “light users,” corresponding to low “hourly viewership” data values and low normalized hourly viewership data values. However, a probability distribution with equally weighted modes implicitly suggests that the distribution of “light users,” “medium users,” and “heavy users” is roughly equal. More accurate Gaussian mixture model techniques can be used to produce probability distributions that greater reflect the actual distribution of categories in the data records. However, such techniques are dependent on the actual distribution of data values, and as such introduce another means for the leakage of sensitive data. Knowing, for example, the relative proportion of data records corresponding to each category may enable an individual to identify a particular data record, based in part by its category. Using equally weighted modes however, is independent of the actual distribution of the data, and therefore does not leak any information about the distribution of data values in data records, thereby preserving privacy.

At this point, the computer system can now count and combine categories (steps 404-412) in order to train the machine learning model in a privacy-preserving manner (step 418). As described above in Section I, if any categories are deficient, i.e., correspond to too few data records, they may be sampled too often during training, and may risk exposing private data contained in those data records. By counting and combining deficient categories, the sampling probability can be reduced, thereby improving privacy.

### B. Category Counting and Merging

Returning to FIG. 4, at step 404, the computer system can determine a plurality of noisy category counts corresponding to a plurality of categories. Each noisy category count can indicate an estimated (e.g., an approximate) number of data records of the plurality of data records (retrieved at step 402) that belong to each category of the plurality of categories. For example, if the data records correspond to patient health information, the computer system can determine the estimated or approximate number of data records corresponding to “elderly” patients, “low blood pressure” patients, patients with active health insurance, etc. Each noisy category count can comprise a sum of a category count (of the plurality of category counts) and a category noise value of one or more category noise values. For example, the same category noise value can be added to each category count, in which case the one or more category noise values can comprise a single noise value. As an alternative, a different category noise value can be added to each category count, in which case the one or more category noise values can comprise a plurality of category noise values.

Each category noise value can be defined by a category noise mean and a category noise standard deviation σ_{count}. The category noise mean and the category noise standard deviation may correspond to a probability distribution which can be used to determine the category noise values. For example, each category noise value can be sampled from a normally-distributed Gaussian distribution (sometimes referred to as a “first gaussian distribution”) with mean equal to the category noise mean and standard deviation equal to the category noise standard deviation.

As described above, the process of (noiseless) counting can violate the definition of differential privacy, as two data sets, one comprising a particular data record and one not comprising that data record, can result in different data record counts. As such, a noiseless category count can, in theory, enable an individual to determine whether a particular data record was included in a particular category. As such, category noise values can be added to the category noise counts to determine the noisy category counts, which indicate an estimated (or approximate) number of data records corresponding to each category, and therefore protect privacy. Generally, a larger category noise standard deviation results in a wider variety of category noise values that can be added to the category counts, and as such, provides greater privacy than a smaller category noise standard deviation.

As such, the category noise mean and category noise standard deviation can be determined based on one or more category noise parameters, which can include one or more target privacy parameters related to the particular privacy requirements for artificial data generation. The target privacy parameters can correspond to a desired level of privacy, and can include an epsilon (ε) privacy parameter and a delta (δ) used to characterize the differential privacy of the training of the machine learning system. The category noise parameters can further comprise a minimum count L (used to identify if a category is deficient, i.e., corresponding to too few data records), a maximum number of non-zero data values Xₘₐₓ (used to remove non-sparse data records, as described above), a safety margin a, and a total number of data values in a given data record V.

The relationship between the category noise mean, category noise standard deviation, and category noise parameters may not have a closed form or an otherwise accessible parametric relationship. In some cases, a “privacy analysis” may be performed, either by the computer system or by a data analyst operating the computer system, in order to determine the category noise mean and category noise standard deviation based on the category noise parameters. For example a “worst case” privacy analysis can be performed based on a “worst case value” of

$$\frac{{X}_{max}}{V} * \frac{1}{L - a} ,$$

i.e., the maximum number of non-zero data values Xₘₐₓ divided by the total number of data values in a given data record V, multiplied by one divided by the minimum count/minus the safety margin a. If later model training (e.g., at step 418) uses batches b of size b>1, the worst case value can instead by represented by

$$\frac{{X}_{max}}{V} * {\sum }_{i ∈ ( 0 , 1 , … , b - 1 )} \frac{1}{L - a - i} .$$

The privacy analysis can also be used to determine a number of training rounds to perform during model training. Further information about privacy analyses and how they can be performed can be found in references [6] and [7].

Either of these worst case values can relate to the probability that a particular data value contained in a particular data record is sampled during training, which is further proportional to privacy risk, as defined by the (ε,δ) differential privacy definition provided in Section I. As such, the category noise mean and category noise standard deviation can be determined based on a worst case value. For example, to accommodate to a large worst case value (indicating larger privacy risk) a large category noise standard deviation can be determined, whereas for a smaller worst case value (indicating lower privacy risk), a smaller category noise standard deviation can be determined.

At step 406, after determining the noisy category counts, the computer system can identify deficient categories based on the category noise count and a minimum count. Each deficient category can comprise a category for which the corresponding noisy category count is less than a minimum count. For example, if the minimum category count is “1000” and a category (e.g., “popular restaurants” for data records corresponding to restaurants) only comprises 485 data records, that category may be identified as a deficient category. The computer system can parse through the retrieved data records and increment a category count corresponding to each category whenever the computer system encounters a data record corresponding to that category.

As described above, the probability that any given data record or data value is sampled in training can be proportional to the number of data records in a given category. As such, deficient categories pose a greater privacy risk because they correspond to less data records. Deficient categories can be combined (e.g., in step 408) in order to address this privacy risk and provide differential privacy. Like the category noise standard deviation, the minimum count may be determined, wholly or partially, by a privacy analysis, which can involve determining a minimum count based on, e.g., particular (ε,δ) privacy parameters.

At step 408, the computer system can combine each deficient category of the one or more categories (e.g., identified in step 406) with at least one other category of the plurality of categories, thereby determining a plurality of combined categories. Generally, the combined categories preferably comprise a number of data records greater than the minimum count. However, categories can be combined in any appropriate manner. For example, deficient categories can be combined with other deficient categories to produce a combined category that is not deficient (i.e., contains more data records than the minimum count). Alternatively, a deficient category can be combined with a non-deficient category to achieve the same result. Deficient categories can be combined with similar categories. For example, for medical data records, if the category “very old” is a deficient category, this category can be combined with the similar category “old” to create a combined “old/very old” category. While such a category combination may be logical, or may result in more representative artificial data, there is no strict requirement that categories need to be combined in this way. As an alternative, the “very old” category could be combined with a “newborn” category if both categories were deficient and if combining the categories would result in a non-deficient “very old/new born” category.

At step 410, the computer system can identify one or more deficient data records. Each deficient data record can contain at least one deficient data value, which can correspond to a combined category. For example, if the “very old” category was found to be deficient, and a combined “old/very old” category was generated at step 408, the computer system can identify deficient data records that contain data values corresponding to either the “old” category or the “very old” category. The computer system can do so by iterating through the retrieved data records and their respective data values to identify these deficient data records and deficient data values.

At step 412, the computer system can replace deficient data values in the deficient data records with combined data values. For each deficient data value contained in the one or more deficient data records, the computer system can replace that deficient data value with a “combined data value” identifying a combined category of the plurality of categories. For example, if the computer system identifies a deficient health data record containing a deficient data value that identifies the “very old” category (which has been combined into the “old/very old” category), the computer system can replace that deficient data value with a data value that identifies the combined “old/very old” category instead of the “old” category. This combined data value can further include noisy category counts corresponding to each category in the combined category.

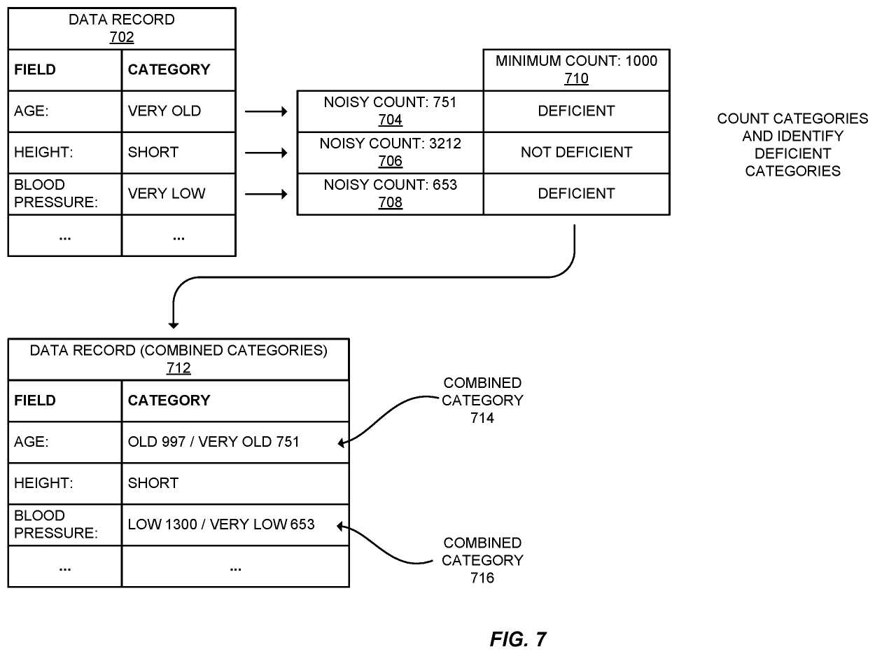

The process of steps 404-412 may be better understood with reference to FIG. 7, which shows an exemplary data record 702. This data record 702 shows three data fields, corresponding to age, height, and blood pressure, as well as three categories corresponding to those three data fields (i.e., very old, short, and very low blood pressure). The computer system can determine a noisy category count corresponding to each of these categories (e.g., at step 404 of FIG. 4).

FIG. 7 shows three such noisy category counts. The “old” noisy category count 704 comprises approximately 751 data records. The “short” noisy category count 706 comprises approximately 3212 data records. The “very low blood pressure” noisy category count 708 comprises approximately 653 data records.

The computer system can compare each of these noisy category counts 704-708 to a minimum count 710 (i.e., 1000) in order to identify if any of these categories are deficient, e.g., at step 406 of FIG. 4. Based on this comparison, the computer system can determine that the “very old” category and the “very low blood pressure” category are deficient (and therefore any data values contained in the data record 702 that indicate these categories are deficient data values), while the “short” category is not deficient. The computer system can combine these deficient categories with other categories (e.g., at step 408 of FIG. 4). In the example of FIG. 7, the computer system could combine the “very old” category with an “old” category to create a combined “old/very old” category. Likewise, the computer system can combine the “very low blood pressure” category with a “low blood pressure” category to create a combined “low/very low blood pressure category.”

Afterwards, the computer system can (e.g., at step 410 of FIG. 4) identify any deficient data records in the data set, including data record 702, which comprises data values identifying two different deficient categories. The computer system can then replace the deficient data values in these deficient data records with combined data values. These combined data values can identify a combined category, and can additionally include the noisy category counts corresponding to the categories in that combined category. For example, in FIG. 7, the updated data record 712 has an “age” data value “old 997/very old 751” that indicates the combined “old/very old” category, as well as the noisy category counts for both the “old” and “very old” categories.

Referring back to FIG. 4, at step 414, the computer system can generate a plurality of conditional vectors to use during training. Each conditional vector can identify one or more particular data fields. These data fields may be used to determine data values that a generator sub-model should replicate or reproduce during training. Referring briefly to FIG. 2 again, the value “1” in the third position of conditional vector 214 can indicate that a generator should replicate a data value corresponding to the “data usage” field during training. As such, this exemplary conditional vector identifies this data field. In some embodiments, each conditional vector can comprise the same number of elements as each data record.

The conditional vectors can be generated in any appropriate manner, including randomly or pseudorandomly. In some cases, it may be preferable to generate conditional vectors such that they identify data fields with equal probability. For example, if the plurality of data records each comprise ten data fields, the probability of any particular data field being identified by a generated conditional vector may be equal (approximately 10%). Alternatively, it may be preferable to generate conditional vectors that “prioritize” certain data fields over other data fields. This may be the case if, for example, one particular data field is more associated with minority data records than other data fields. In this case, minority data representation may be better achieved if the conditional vectors identify this data field more often than other data fields.

At step 416, the computer system can sample a plurality of sampled data records from the plurality of data records. These sampled data records can include at least one of the one or more deficient data records (e.g., identified at step 410). Each sampled data record can comprise a plurality of sampled data values corresponding to the plurality of data fields. These sampled data records can comprise the data records used for machine learning model training (e.g., at step 418). In some embodiments, all of the data records retrieved from the data source (excluding those that were filtered or removed, e.g., for being non-sparse) can be sampled and used as sampled data records for training. Additionally at step 416, the computer system can process these sampled data records, particularly if any sampled data records contain sampled data values that identify a combined category.

### Processing Sampled Data Records Prior to Training

Sampled data records that contain data values identifying a combined category can be updated to identify a single category. This may be useful in conjunction with conditional vectors. If a conditional vector indicates a data field that includes two categories (e.g., “old 997/very old 751”), it may be difficult to use a conditional vector to identify a singular category or date value to reproduce in training. As such, the computer system can update a data value that identifies a combined category such as “old 997/very old 751” to identify a single category, e.g., “old” or “very old.”

At step 418, prior to the step of training the machine learning model to generate the plurality of artificial data records, the computer system can identify one or more sampled data values from the plurality of sampled data records. Each identified sampled data value of the one or more identified sampled data values can correspond to a corresponding combined category of one or more corresponding combined categories. The computer system can accomplish this by iterating through the data values in each sampled data record and identify whether those data values correspond to a combined category. Such data values may include strings, flags, or other indicators that indicate they correspond to a combined category, or may be in a form that indicates they correspond to a combined category, e.g., a string such as “old/very old” can define two categories (“old” and “very old”) based on the position of the backslash.

For each identified sampled data value, the computer system can determine two or more categories that were combined to create each of the corresponding combined categories. For example, for a string data value such as “old 997/very old 751”, the computer system can determine that the two categories are “old” and “very old” based the structure of the string. The computer system can then randomly select a random category from the two or more categories, e.g., by randomly selecting either “old” or “very old” from the example given. The computer system can then generate a replacement sampled data value that identifies the random category and replace the identified sampled data value with the replacement sampled data value. In this way, each sampled data record can now identify a single category per data field, rather than any combined categories.

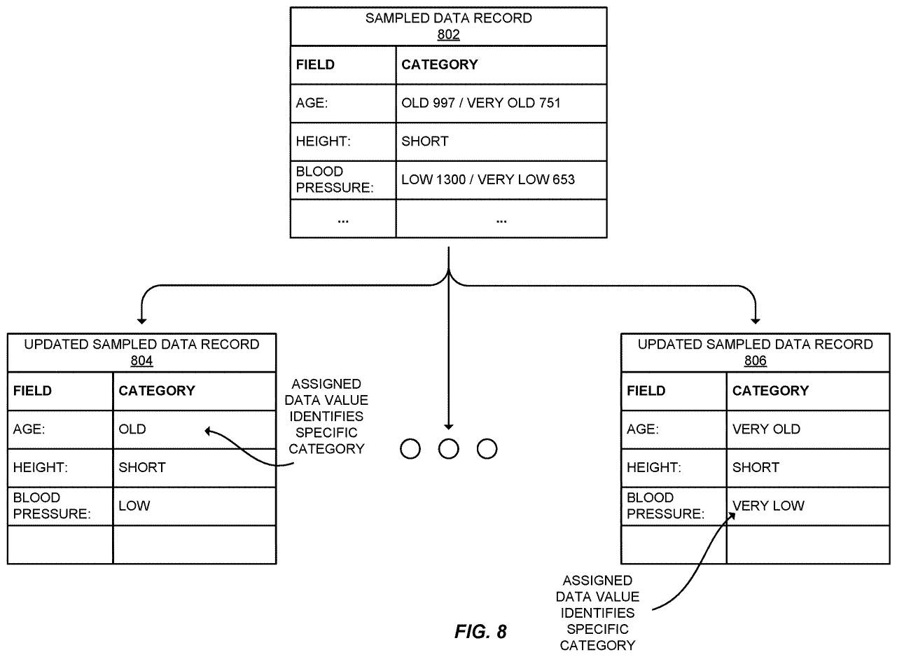

This process may be better understood with reference to FIG. 8, which shows an exemplary sampled data record 802 corresponding to health data, with data fields corresponding to age, height, and blood pressure. The age data field (and the data value corresponding to this data field) correspond to a combined “old 997/very old 751” category. Likewise, the blood pressure data field (and the data value corresponding to this data field) corresponds to a combined “low 1300/very low 653” category.

This sampled data record can be updated so that both data values corresponding to age and blood pressure identify a single category, rather than a combined category. There are four possible combinations of identified categories. Two such possible combinations are shown in updated sampled data record 804 and updated sampled data record 806. In updated sampled data record 804, the category “old” has been randomly selected to replace the combined category “old 997/very old 751”, and the category “low” has been randomly selected to replace the combined category “low 1300/very low 653”. Likewise, in updated sampled data record 806, the category “very old” has been randomly selected to replace the combined category “old 997/very old 751”, and the category “very low” has been selected to replace the combined category “low 1300/very low 653”.

While individual data values are not pictured in FIG. 8, such data values can indicate their corresponding category. For example, if a normalized data range of 0.0 to 0.2 was assigned to the “very low blood pressure” category (e.g., using a multi-modal distribution as described above). The data value corresponding to the blood pressure field could be replaced with a replacement data value corresponding to any number in this range (e.g., 0.1) selected by any appropriate means (e.g., the mean data value in this range, a random data value in this range, etc.). Alternatively, the replacement data value could comprise a string or other identifier identifying the corresponding category (e.g., “low blood pressure”).

In some embodiments, the random category can be selected using a weighted random sampling, using any noisy category counts indicated by a combined category. For example, for the combined “old 997/very old 751” category, the probability of randomly selecting the “old” category could be equal to

$$\frac{997}{997 + 751} ,$$

while the probability of randomly selecting the very old category could be equal

$$to \frac{751}{751 + 997} .$$

The computer system could, for example, uniformly sample a random number on a range of 1 to (997+751). If the sampled random number is 997 or less, the computer system could randomly select the “old” category. If the sampled random number is 998 or greater, the computer system could randomly select the “very old category”

Returning to FIG. 4, at step 418, the computer system can train the machine learning model to generate a plurality of artificial data records using the plurality of sampled data records and the plurality of conditional vectors. Each artificial data record can comprise a plurality of artificial data values corresponding to the plurality of data fields. These plurality of data fields can include the one or more data fields identified by the conditional vectors. The machine learning model can replicate one or more sampled data values corresponding to the one or more particular data fields in the plurality of artificial data values according to the plurality of conditional vectors.

In slightly more accessible terms, if a particular conditional vector (used during a particular training round) identifies a data field such as a “height” data field in a medical data record, the machine learning model can replicate the “height” value, corresponding to a particular sampled data record (used during that particular training round), in the plurality of artificial data records. In this way, the machine learning model can learn to generate artificial data records that are representative of the sampled data records as a whole. In this context, to “replicate” generally means to create with intent to copy. The machine learning model is not necessarily capable of (particularly in early rounds of training) exactly copying the one or more sampled data values identified by the conditional data vectors. Even once training has been completed, the machine learning model still may not copy such values exactly. For example, if a conditional vector identifies a sampled data value of “0.7,” the machine learning model may “replicate” such a data value in an artificial data record to be “0.689”.

As described above, the machine learning model can comprise an autoencoder (such as a variational autoencoder), a generative adversarial network, or a combination thereof. In some embodiments, the machine learning model can comprise a generator sub-model and a discriminator sub-model. The generator sub-model can be characterized by a plurality of generator parameters. Likewise, the discriminator sub-model can be characterized by a plurality of discriminator parameters. In some embodiments, the generator sub-model may be implemented using an artificial neural network (also referred to as a “generator artificial neural network”) and the generator parameters may comprise a plurality of generator weights corresponding to the generator artificial neural network. Likewise, the discriminator sub-model may be implemented using an artificial neural network (also referred to as a “discriminator artificial neural network”) and the discriminator parameters may comprise a plurality of discriminator weights corresponding to the discriminator artificial neural network.

At any time during the method of FIG. 4, the computer system may perform a “privacy analysis,” such as the “worst case” privacy analysis described above with reference to category counting and merging. This privacy analysis may inform some of the steps performed by the computer system. As described above, embodiments of the present disclosure provide for differentially-private machine learning model training. The “level” of privacy provided by embodiments may be defined based on target privacy parameters such as an epsilon (ε) privacy parameter and a delta (δ) privacy parameter. The computer system may perform this privacy analysis in order to guarantee that the privacy of the machine learning training is consistent with these privacy parameters.

As an example, the privacy of this training process can be proportional to the amount of category noise added to the noisy category counts. Greater noise may provide more privacy at the cost of lower artificial data representativeness. The computer system can perform this privacy analysis to determine how much category noise to add to the noisy category counts in order to achieve differential privacy consistent with the target privacy parameters. As another example, the privacy provided by a machine learning model typically reduces with each training round or epoch. However, more training rounds generally result in more accurate or representative artificial data records. As such the computer system can perform this privacy analysis in order to determine the number of training rounds or epochs to perform during step 418.

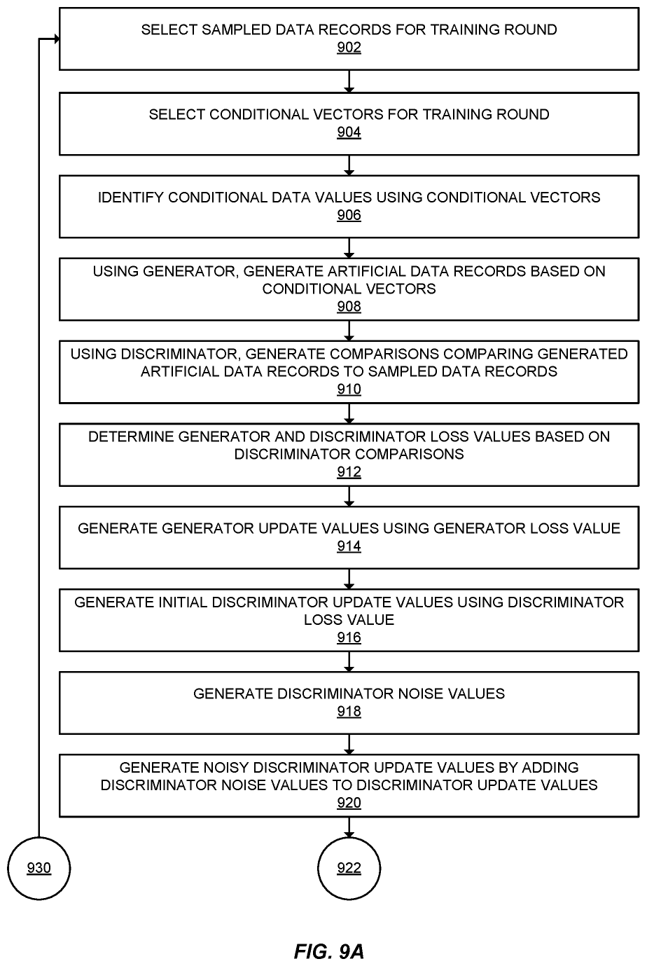

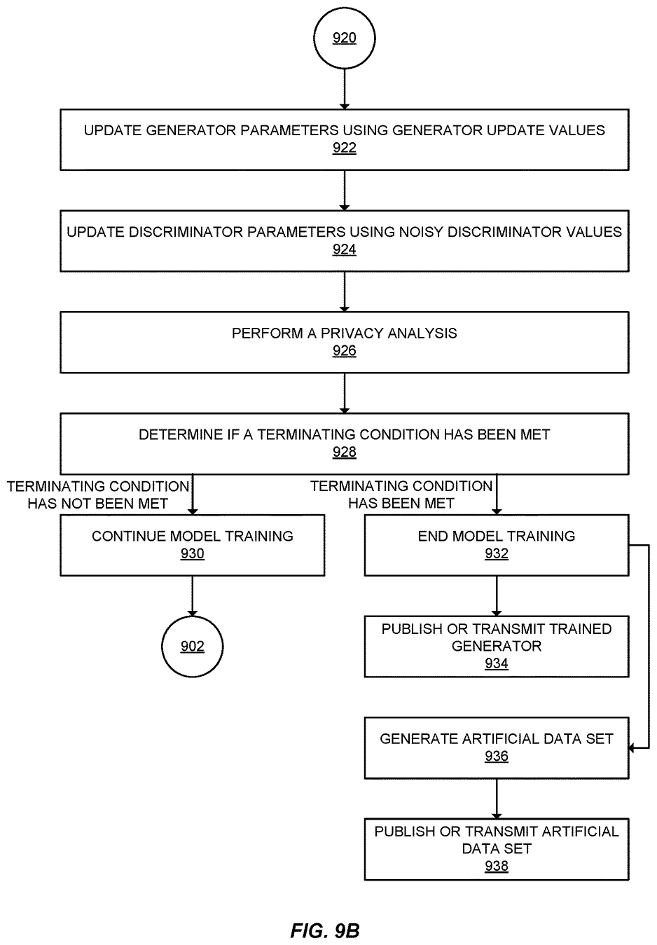

In some embodiments, training the machine learning model can comprise an iterative training process comprising some number of training rounds or epochs. This iterative training process can be repeated until a terminating condition has been met. An exemplary training process is described with reference to FIGS. 9A-9B.

### IV. MODEL TRAINING

FIGS. 9A-9B illustrate an exemplary method of training a machine learning model to generate a plurality of artificial data records. This method can preserve the privacy of sampled data values contained in a plurality of sampled data records used during the training, e.g., by providing (ε,δ) differential privacy. Prior to performing this training process, a computer system can acquire a plurality of sampled data records. Each sampled data record can comprise a plurality of sampled data values. Likewise, the computer system can acquire a plurality of conditional vectors. Each conditional vector can identify one or more particular data fields. The computer system can acquire these sampled data records and conditional vectors using the methods described above, e.g., with reference to FIG. 4. However, the computer system can also acquire these sampled data records and conditional vectors via some other means. For example, the computer system could receive the sampled data records and conditional vectors from another computer system, or from a database of pre-processed sampled data records and conditional vectors, or from any other source.

This training can comprise an iterative process, which can comprise a number of training rounds and/or training epochs.

At step 902, the computer system can determine one or more chosen sampled data records of the plurality of sampled data records. These chosen sampled data records may comprise the sampled data records used in a particular round of training. For example, if there are 10,000 training rounds, each with a batch size of 100, the computer system can choose 100 chosen sampled data records to use in this particular training round. Alternatively, if the batch size is one, the computer system can choose a single chosen sampled data record to use in this particular training round.

At step 904, the computer system can determine one or more chosen conditional vector. Like the chosen sampled data records, these chosen conditional vectors can be used in a particular training round, and may be dependent on the batch size. In some embodiments, there may be an equal number of chosen conditional vectors as chosen sampled data records for a particular training round.

At step 906, the computer system can identify one or more conditional data values from the one or more chosen sampled data records. These one or more conditional data values can correspond to one or more particular data fields identified by the one or more conditional vectors. Referring briefly to FIG. 2 for an example, conditional vector 214 identifies a “data usage” data field 204 (among other data fields). If data records 212 was a chosen sampled data record, the computer system could use conditional vector 214 to identify the data value “0.7” corresponding to the “data usage” data field identified by conditional vector 214. This data value “0.7” can then comprise a conditional data value.

At step 908, the computer system can generate one or more artificial data records using the one or more conditional data values and a generator sub-model. As described above, the generator sub-model can be characterized by a plurality of generator parameters, such as a plurality of generator neural network weights that characterize a neural network based generator sub-model. The generator sub-model can replicate (or attempt to replicate) the one or more conditional data values in the one or more artificial data records. The number of artificial data records generated by the generator sub-model may be proportional to the batch size. For example if the batch size is one, the generator sub-model may generate a single artificial data record, while if the batch size is 100, the generator sub-model may generate 100 artificial data records.

At step 910, the computer system can generate one or more comparisons using the one or more chosen sampled data records, the one or more artificial data records, and a discriminator sub-model. The discriminator sub-model can be characterized by a plurality of discriminator parameters, such as a plurality of discriminator neural network weights that characterize a neural network based discriminator sub-model. These comparisons can comprise classification outputs produced by the discriminator for the one or more artificial data records or for one or more pairs of artificial data records and chosen sampled data records. For example, for a particular artificial data record, the discriminator sub-model could produce a comparison such as “artificial, 80%”, indicating that the discriminator sub-model classifies that artificial data record as artificial with 80% confidence. As another example, for two data records “A”, and “B”, one of which is an artificial data record and the other which is a chosen sampled data record, the discriminator sub-model could generate a comparison such as “B, artificial, 65%” indicating that of the two provided data records “A” and “B”, the discriminator predicts that “B” is the artificial data record with 65% confidence.

At step 912, the computer system can determine a plurality of loss values. This plurality of loss values can comprise a generator loss value and a discriminator loss value. The computer system can determine the plurality of loss values based on the one or more comparisons between the one or more artificial data records generated during training (e.g., at step 908) and one or more sampled data records of the plurality of sampled data records. These loss values can be used, generally, to evaluate the performance of the generator sub-model and the discriminator sub-model, which can be used to update the parameters of the generator sub-model and the discriminator sub-model in order to improve their performance. As such, these loss values can be proportional to a difference between the ideal or intended performance of the generator sub-model and the discriminator sub-model. For example, if the discriminator predicts (as indicated by a comparison of the one or more comparisons) that an artificial data value is an artificial data value with high confidence (e.g., 99%), then the discriminator is generally succeeding at its intended function of discriminating between artificial data records and sampled data records. As such, the discriminator loss value may be low (indicating that little change is needed for the discriminator parameters).

Alternatively, if the discriminator predicts that an artificial data value is a real data value with high confidence, then not only has the discriminator misidentified the artificial data records, but it is also very confident in its misidentification. As such, the discriminator loss value may be high (indicating that a large change is needed for the discriminator parameters). Similar reasoning can be applied to the generator loss value, i.e., if the generator generates artificial data records that successfully deceive the discriminator, then the generator loss value may be low, otherwise the generator loss value may be high. For batches larger than one, the generator loss values and discriminator loss values may be based off the average of the generator and discriminator performance over all of the one or more sampled data records and one or more artificial data records.

The computer system can now determine a plurality of model update values which can be used to update the machine learning model. These can include a plurality of generator update values that can be used to update the generator parameters, and thereby update the generator sub-model. Likewise, these model update values can include a plurality of noisy discriminator update values that can be used to update the discriminator parameters, and thereby update the discriminator sub-mode.

At step 914, the computer system can generate one or more generator update values based on the generator loss value. The computer system can use a generator optimizer component or software routine (e.g., as depicted in FIG. 3) to generate the one or more generator update values. This generator optimizer can implement any appropriate optimization method, such as stochastic gradient descent. In such a case, the one or more generator update values can comprise one or more generator gradients or one or more values derived from one or more generator gradients. In broad terms, the computer system can use the generator optimizer to determine what change in generator model parameters results in the largest immediate reduction to the generator loss value (determined, for example, based on the gradient of the generator loss value), and the generator model update values can reflect, indicate, or otherwise be used to carry out that change to the generator parameters.

At step 916, the computer system can generate one or more initial discriminator update values based on the discriminator loss value. The computer system can use a discriminator optimizer component or software module (e.g., as depicted in FIG. 3) to generate the one or more discriminator update values. The discriminator optimizer can implement any appropriate optimization method, such as stochastic gradient descent. In such a case, the one or more initial discriminator values can comprise one or more discriminator gradients or one or more values derived from the one or more discriminator gradients. In broad terms, the computer system can use the discriminator optimizer to determine what change in discriminator model parameters results in the largest immediate reduction to the initial discriminator loss value (determined, for example, based on the gradient of the initial discriminator loss value), and the discriminator model update values can reflect, indicate, or otherwise used to carry out that change to the discriminator parameters.

At step 918, the computer system can generate one or more discriminator noise values. These discriminator noise values may comprise random or pseudorandom numbers sampled from a Gaussian distribution (sometimes referred to as a “second Gaussian distribution”, in order to distinguish it from a Gaussian distribution used to sampled category noise values (as described above with reference to FIG. 4). In order to generate the one or more discriminator noise values, the computer system can determine a discriminator standard deviation. The second Gaussian distribution may have a mean of zero and a standard deviation equal to this discriminator standard deviation. The discriminator standard deviation can be based (wholly or in part) on the particular privacy requirements of the system, including those indicated by a pair of (ε,δ) differential privacy parameters. For example, the computer system may determine a larger standard deviation for stricter privacy requirements, and determine a smaller standard deviation for less strict privacy requirements.

At step 920, the computer system can generate one or more noisy discriminator update values (sometimes referred to more generically as “discriminator update values”) by combining the one or more initial discriminator update values and the one or more discriminator noise values. This can be accomplished by calculating one or more sums of the one or more initial discriminator update values and the one or more discriminator noise values, and the one or more noisy discriminator update values can comprise these sums. As described above (see e.g., Section I. D), adding noise to these discriminator model update values can help achieve differential privacy.

Once the model update values (e.g., the one or more generator update values and the one or more discriminator update values) have been determined, the computer system can update the plurality of model parameters (e.g., the plurality of generator parameters and the plurality of discriminator parameters) based on these model update values.

Referring to FIG. 9B, at step 922, the computer system can update the generator sub-model by updating the plurality of generator parameters using the one or more generator update values.

At step 924, the computer system can update the discriminator sub-model by updating the plurality of discriminator parameters using the one or more discriminator update values. This updating process can depend on the specific nature of the generator and discriminator sub-models, their model parameters, and the update values. As a non-limiting example, for generator and discriminator sub-models based on artificial neural network architectures (e.g., as in a GAN), techniques such as backpropagation can be used to update the generator and discriminator model parameters based on the generator update values and discriminator update values.

Optionally, at step 926, the computer system can perform a privacy analysis of the model training. In non-private machine learning applications, the training phase is often performed for a set number of training rounds or until model parameters have converged, e.g., are not changing much (or at all) in successive training rounds. However, as described above, the privacy of a machine learning model is proportional to the probability of sampling a particular data value or data record during training. The more training rounds that are performed, the greater the probability that a given data record or data value is sampled, and as a result, any privacy guaranteed by the machine learning model generally declines with each successive training round (see e.g., [2] for more detail).

As such, a privacy analysis can be performed to determine generally how much of the “privacy budget” has been used by training. To perform this privacy analysis, the computer system can determine one or more privacy parameters corresponding to a current state of the machine learning model. These one or more privacy parameters can comprise an epsilon privacy parameter and a delta privacy parameter, which may characterize the differential privacy of the machine learning model. The computer system can compare the one or more privacy parameters to one or more target privacy parameters, which can comprise a target epsilon privacy parameter and a target delta privacy parameter. If the epsilon privacy parameter and the delta privacy parameter equal or exceed their respective target privacy parameters, this can indicate that further training may violate any differential privacy requirements placed on the system.

At step 928, the computer system can determine if a terminating condition has been met. The terminating condition can define the condition under which training has been completed. For example some machine learning model training procedures involve training the model for a predetermined number of training rounds or epochs. In such a case, determining whether a terminating condition has been met can comprise determining whether a current number of training rounds or a current number of training epochs is greater than or equal to a predefined number of training rounds or number of training epochs.

As another example, if the computer system performed a privacy analysis at step 926, the computer system can compare the one or more privacy parameters (e.g., the epsilon and delta privacy parameters) to one or more target privacy parameters (e.g., the target epsilon and target delta privacy parameter) and determine that the terminating condition has been met if the one or more privacy parameters are greater than or equal to the one or more target privacy parameters.

If the terminating condition has not been met, the computer system can proceed to step 930 and repeat the iterative training process. The computer system can return to step 902 and select new sampled data records for the subsequent training round. The computer system can repeat steps 902-928 until the terminating condition has been met. Otherwise, if the terminating condition has been met, the computer system can proceed to step 932 and can terminate the iterative training process. The generator sub-model can now be used to generate representative, differentially-private artificial data records.

### V. POST-TRAINING

After training the machine learning model to generate the plurality of artificial data records, the machine learning model may be referred to as a “trained machine learning model.” A component of the machine learning model, such as the generator sub-model may be referred to as a “trained generator.” Any artificial data records generated by this trained generator may protect the privacy of the sampled data records used to train the machine learning model, based on any privacy parameters used during this training process. As such, the trained generator or artificial data records generated by the trained generator may be used safely, for example, by an artificial data using entity, as depicted in FIG. 1.

Optionally, at step 934, the computer system can publish the trained generator (e.g., on a publicly accessible website or database). Alternatively, the computer system can transmit the trained generator to a client computer. The client computer can then use the trained generator to generate an artificial data set comprising a plurality of output artificial data records. In some cases, the client computer can generate and use its own conditional vectors (which may be distinct and independent from conditional vectors used during model training) in order to encourage the trained generator to generate artificial data records with specific characteristics. For example, if a medical research organization is interested in statistical analysis of health characteristics of elderly individuals, the medical research organization could use conditional vectors to cause the trained generator to generate artificial data records corresponding to elderly individuals.

As an alternative, at step 936, the computer system can use the trained machine learning model (e.g., the trained generator) to generate an artificial data set comprising a plurality of output artificial data records. Subsequently at step 938, the computer system can transmit this artificial data set to a client computer. The client computer can then use this artificial data set as desired. For example, a client associated with the client computer can use an artificial data set to train a machine learning model to perform some useful function or perform statistical analysis on this data set, as described, e.g., in Section I. These artificial data records preserve the privacy of any sampled data records used to train the machine learning model, regardless of the nature of post-processing performed by client computers.

### VI. COMPUTER SYSTEM

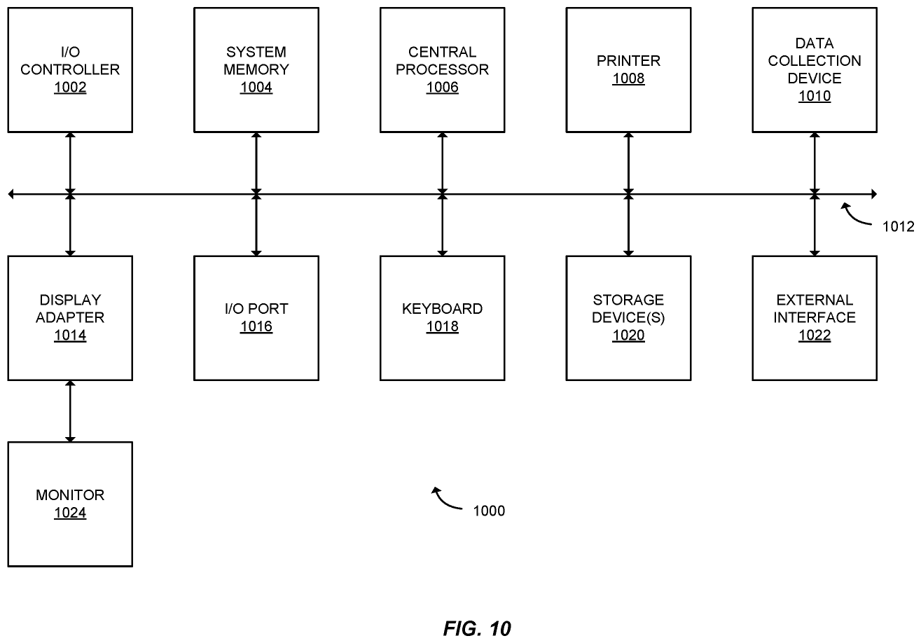

Any of the computer systems mentioned herein may utilize any suitable number of subsystems. Examples of such subsystems are shown in FIG. 10 in computer system 1000. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 10 are interconnected via a system bus 1012. Additional subsystems such as a printer 1008, keyboard 1018, storage device(s) 1020, monitor 1024 (e.g., a display screen, such as an LED), which is coupled to display adapter 1014, and others are shown. Peripherals and input/output (I/O) devices, which couple to I/O controller 1002, can be connected to the computer system by any number of means known in the art such as input/output (I/O) port 1016 (e.g., USB, FireWire®). For example, I/O port 1016 or external interface 1022 (e.g. Ethernet, Wi-Fi, etc.) can be used to connect computer system 1000 to a wide area network such as the Internet, a mouse input device, or a scanner. The interconnection via system bus 1012 allows the central processor 1006 to communicate with each subsystem and to control the execution of a plurality of instructions from system memory 1004 or the storage device(s) 1020 (e.g., a fixed disk, such as a hard drive, or optical disk), as well as the exchange of information between subsystems. The system memory 1004 and/or the storage device(s) 1020 may embody a computer readable medium. Another subsystem is a data collection device 1010, such as a camera, microphone, accelerometer, and the like. Any of the data mentioned herein can be output from one component to another component and can be output to the user.

A computer system can include a plurality of the same components or subsystems, e.g., connected together by external interface 1022, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface. In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can be involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may be involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications and description mentioned herein are incorporated by reference in their entirety for all purposes. None is admitted to be prior art.

### VII. REFERENCES

[1] Dwork, Cynthia, and Aaron Roth. “The Algorithmic Foundations of Differential Privacy.” Foundations and Trends in Theoretical Computer Science 9, no. 3-4 (2014): 211-407.
[2] Abadi, Martin, Andy Chu, Ian Goodfellow, H. Brendan McMahan, Ilya Mironov, Kunal Talwar, and Li Zhang. “Deep Learning with Differential Privacy.” In Proceedings of the 2016 ACM SIGSAC Conference on Computer and Communications Security, pp. 308-318. 2016
[3] Goodfellow, Ian, Jean Pouget-Abadie, Mehdi Mirza, Bing Xu, David Warde-Farley, Sherjil Ozair, Aaron Courville, and Yoshua Bengio. “Generative Adversarial Nets.” In Advances in Neural Information Processing Systems, pp. 2672-2680. 2014.
[4] Xie, Liyang, Kaixiang Lin, Shu Wang, Fei Wang, and Jiayu Zhou. “Differentially Private Generative Adversarial Network.” arXiv prepritn arXiv:1802.06739 (2018).
[5] Xu, Lei, Maria Skoularidou, Alfredo Cuesa-Infante, and Kalyan Veeramachaneni. “Modeling Tabular Data Using Conditional GAN.” In Advances in Neural Information Processing Systems, pp. 7335-7345. 2019.
[6] Li, Qiongxiu, Jaron Skovsted Gundersen, Katrine Tjell, Rafal Wisniewski, Mads Gæsboll Christensen, “Privacy-Preserving Distributed Expectation Maximization for Gaussian Mixture Model Using Subspace Perturbation,” ICASSP 2022-2022 IEEE International Conference on Acoustics. Speech, and Signal Processing (ICASSP). Singapore, Singapore, 2022, pp. 4263-4267, doi: 10.1109/ICASSP43922.2022.9746144
[7] Shashanka, Madhusudana, “A Privacy Preserving Framework for Gaussian Mixture Models,” 2010 IEEE International Conference on Data Mining Workshops. Sydney, NSW Australia, 2010, pp. 499-506, doi: 10.1109/ICDMW.2010.109

1. A method performed by a computer system for training a machine learning model to generate a plurality of artificial data records in a privacy-preserving manner, the method comprising:
retrieving a plurality of data records, each data record comprising a plurality of data values corresponding to a plurality of data fields, each data value being within a category of a plurality of categories;
determining a plurality of noisy category counts corresponding to the plurality of categories, each noisy count indicating a number of data records of the plurality of data records that belong to each category of the plurality of categories;
identifying one or more deficient categories, each deficient category comprising a category for which a corresponding noisy category count is less than a minimum count;
combining each deficient category of the one or more deficient categories with at least one other category of the plurality of categories, thereby determining a plurality of combined categories;
identifying one or more deficient data records from the plurality of data records, each deficient data record containing at least one deficient data value corresponding to a combined category;
for each deficient data value contained in the one or more deficient data records, replacing the deficient data value with a combined data value identifying a combined category of the plurality of combined categories;
generating a plurality of conditional vectors, each conditional vector identifying one or more particular data fields of the plurality of data fields for use in replicating;
sampling a plurality of sampled data records from the plurality of data records, wherein the plurality of sampled data records include at least one of the one or more deficient data records, each sampled data record comprising a plurality of sampled data values corresponding to the plurality of data fields; and
training the machine learning model to generate the plurality of artificial data records using the plurality of sampled data records, each artificial data record comprising a plurality of artificial data values corresponding to the plurality of data fields, wherein in each artificial data record of the plurality of artificial data records, the machine learning model replicates one or more sampled data values of a particular sampled data record corresponding to the one or more particular data fields in the plurality of artificial data values according to the plurality of conditional vectors, wherein the machine learning model is trained based on a comparison between the plurality of artificial data records and the plurality of sampled data records.

2. The method of claim 1, wherein the machine learning model comprises a trained machine learning model after the step of training the machine learning model to generate the plurality of artificial data records, and wherein the method further comprises:
using the trained machine learning model to generate an artificial data set comprising a plurality of output artificial data records; and
transmitting the artificial data set to a client computer.

3. The method of claim 1, further comprising, prior to the step of training the machine learning model to generate the plurality of artificial data records:
identifying one or more identified sampled data values, each identified sampled data value corresponding to a corresponding combined category of one or more corresponding combined categories; and
for each identified sampled data value:
determining two or more categories that were combined to create the corresponding combined category,
randomly selecting a random category from the two or more categories,
generating a replacement sampled data value that identifies the random category, and
replacing the identified sampled data value with the replacement sampled data value.

4. The method of claim 1, wherein each noisy category count comprises a sum of a category count of a plurality of category counts and a category noise value of one or more category noise values, wherein each category noise value is defined by a category noise mean and a category noise standard deviation.

5. The method of claim 4, further comprising:
generating the one or more category noise values by sampling the one or more category noise values from a first Gaussian distribution with the category noise mean and the category noise standard deviation; and
determining the category noise mean and the category noise standard deviation based on one or more category noise parameters including one or more target privacy parameters.

6. The method of claim 5, wherein the one or more target privacy parameters comprise an epsilon privacy parameter and a delta privacy parameter, and wherein the one or more category noise parameters comprise the epsilon privacy parameter, the delta privacy parameter, the minimum count, a maximum number of non-zero data values, a safety margin, and a total number of data values in a data record.

7. The method of claim 1, wherein the machine learning model comprises an autoencoder, a generative adversarial network, or a combination of the autoencoder and the generative adversarial network.

8. The method of claim 1, further comprising prior to determining the plurality of noisy category counts:
for each data record of the plurality of data records, determining if that data record contains more than a maximum number of non-zero data values; and
for each data record that contains more than the maximum number of non-zero data values, removing that data record from the plurality of data records.

9. The method of claim 1, further comprising, prior to determining the plurality of noisy category counts:
for each data record of the plurality of data records, normalizing one or more data values between 0 and 1 inclusive, thereby generating one or more normalized data values;
for each normalized data value of the one or more normalized data values, determining a plurality of normalized categories based on a corresponding probability distribution of one or more probability distributions; and
including the plurality of normalized categories in the plurality of categories.

10. The method of claim 9, wherein each probability distribution of the one or more probability distributions comprises a multi-modal distribution with a predetermined number of equally weighted modes, wherein a number of normalized categories is equal to the predetermined number of equally weighted modes, such that for each normalized category of the plurality of normalized categories there is a corresponding mode of the predetermined number of equally weighted modes.

11. The method of claim 1, wherein the machine learning model is characterized by a plurality of model parameters; and
wherein training the machine learning model comprises an iterative training process comprising:
determining a plurality of loss values, the plurality of loss values based on the comparison between the plurality of artificial data records and the plurality of sampled data records,
determining, based on the plurality of loss values, a plurality of model update values, updating the plurality of model parameters based on the plurality of model update values,
determining if a terminating condition has been met, and
if the terminating condition has been met, terminating the iterative training process, otherwise repeating the iterative training process until the terminating condition has been met.

12. The method of claim 11, wherein:
the machine learning model comprises a generative adversarial network comprising a generator sub-model and a discriminator sub-model;
the plurality of model parameters comprise a plurality of generator parameters that characterize the generator sub-model and a plurality of discriminator parameters that characterize the discriminator sub-model;
the plurality of loss values comprise a generator loss value and a discriminator loss value;
the plurality of model update values comprise one or more generator update values and one or more discriminator update values;
determining, based on the plurality of loss values, a plurality of model update values comprises: determining the one or more generator update values based on the generator loss value, and determining the one or more discriminator update values based on the discriminator loss value; and
updating the plurality of model parameters based on the plurality of model update values comprises: updating the plurality of generator parameters using the one or more generator update values, and updating the plurality of discriminator parameters using the one or more discriminator update values.

13. The method of claim 12, wherein after training the machine learning model, the generator sub-model comprises a trained generator, and wherein the method further comprises:
transmitting the trained generator to a client computer, wherein the client computer uses the trained generator to generate an artificial data set comprising a plurality of output artificial data records.

14. The method of claim 12, wherein the one or more discriminator update values comprise one or more noisy discriminator update values comprising a sum of one or more initial discriminator update values and one or more discriminator noise values, and wherein determining the one or more discriminator update values based on the discriminator loss value comprises:
determining the one or more initial discriminator update values based on the discriminator loss value;
determining a discriminator standard deviation;
generating the one or more discriminator noise values by sampled from a second Gaussian distribution with a mean of zero and a standard deviation equal to the discriminator standard deviation; and
determining the one or more noisy discriminator update values by calculating one or more sums of the one or more initial discriminator update values and the one or more discriminator noise values.

15. The method of claim 12, wherein:
the generator sub-model is implemented using a generator artificial neural network;
the plurality of generator parameters comprise a plurality of generator weights corresponding to the generator artificial neural network;
the one or more generator update values comprise one or more generator gradients or one or more values derived from the one or more generator gradients;
the discriminator sub-model is implemented using a discriminator artificial neural network;
the plurality of discriminator parameters comprise a plurality of discriminator weights corresponding to the discriminator artificial neural network; and
the one or more discriminator update values comprise one or more discriminator gradients or one or more values derived from the one or more discriminator gradients.

16. The method of claim 11, wherein the iterative training process comprises a number of training rounds or a number of training epochs, and wherein determining whether the terminating condition has been met comprises determining whether a current number of training rounds or a current number of training epochs is greater than or equal to the number of training rounds or the number of training epochs.

17. The method of claim 11, wherein determining whether the terminating condition has been met comprises:
determining one or more privacy parameters corresponding to a current state of the machine learning model; and
comparing the one or more privacy parameters to one or more target privacy parameters, wherein the terminating condition has been met if the one or more privacy parameters are greater than or equal to the one or more target privacy parameters.

18. The method of claim 17, wherein the one or more privacy parameters comprise an epsilon privacy parameter and a delta privacy parameter, and wherein the one or more target privacy parameters comprise a target epsilon privacy parameter and a target delta privacy parameter.

19. A method of training a machine learning model to generate a plurality of artificial data records that preserve privacy of sampled data values contained in a plurality of sampled data records, the method performed by a computer system and comprising:
acquiring the plurality of sampled data records, each sampled data record comprising a plurality of sampled data values;
acquiring a plurality of conditional vectors, each conditional vector identifying one or more particular data fields; and
performing an iterative training process comprising:
determining one or more chosen sampled data records of the plurality of sampled data records,
determining one or more chosen conditional vectors of the plurality of conditional vectors,
identifying one or more conditional data values from the one or more chosen sampled data records, the one or more conditional data values corresponding to one or more particular data fields identified by the one or more chosen conditional vectors,
generating one or more artificial data records using the one or more conditional data values and a generator sub-model, wherein the generator sub-model is characterized by a plurality of generator parameters,
generating one or more comparisons using the one or more chosen sampled data records, the one or more artificial data records, and a discriminator sub-model, wherein the discriminator sub-model is characterized by a plurality of discriminator parameters,
determining a generator loss value and a discriminator loss value based on the one or more comparisons,
generating one or more generator update values based on the generator loss value, generating one or more initial discriminator update values based on the discriminator loss value,
generating one or more discriminator noise values,
generating one or more noisy discriminator update values by combining the one or more initial discriminator update values and the one or more discriminator noise values,
updating the generator sub-model by updating the plurality of generator parameters using the one or more generator update values,
updating the discriminator sub-model by updating the plurality of discriminator parameters using the one or more noisy discriminator update values,
determining if a terminating condition has been met, and
if the terminating condition has been met, terminating the iterative training process, otherwise repeating the iterative training process until the terminating condition has been met.

20. A computer system comprising:
a processor; and
a non-transitory computer readable medium coupled to the processor, the non-transitory computer readable medium comprising code, executable by the processor for implementing a method for training a machine learning model to generate a plurality of artificial data records in a privacy-preserving manner, the method comprising:
retrieving a plurality of data records, each data record comprising a plurality of data values corresponding to a plurality of data fields, each data value being within a category of a plurality of categories;
determining a plurality of noisy category counts corresponding to the plurality of categories, each noisy count indicating a number of data records of the plurality of data records that belong to each category of the plurality of categories;
identifying one or more deficient categories, each deficient category comprising a category for which a corresponding noisy category count is less than a minimum count;
combining each deficient category of the one or more deficient categories with at least one other category of the plurality of categories, thereby determining a plurality of combined categories;
identifying one or more deficient data records from the plurality of data records, each deficient data record containing at least one deficient data value corresponding to a combined category;
for each deficient data value contained in the one or more deficient data records, replacing the deficient data value with a combined data value identifying a combined category of the plurality of combined categories;
generating a plurality of conditional vectors, each conditional vector identifying one or more particular data fields of the plurality of data fields for use in replicating;
sampling a plurality of sampled data records from the plurality of data records, wherein the plurality of sampled data records include at least one of the one or more deficient data records, each sampled data record comprising a plurality of sampled data values corresponding to the plurality of data fields; and
training the machine learning model to generate the plurality of artificial data records using the plurality of sampled data records, each artificial data record comprising a plurality of artificial data values corresponding to the plurality of data fields, wherein in each artificial data record of the plurality of artificial data records, the machine learning model replicates one or more sampled data values of a particular sampled data record corresponding to the one or more particular data fields in the plurality of artificial data values according to the plurality of conditional vectors, wherein the machine learning model is trained based on a comparison between the plurality of artificial data records and the plurality of sampled data records.
